(19) United States
(12) Patent Application Publication
(10) Pub. No.: US 2006/0095156 A1
(43) Pub. Date: May 4, 2006

(54) Method and system for tactical airline system management

(76) Inventors: R. Michael Baiada, Evergreen, CO (US); Lonnie H. Bowlin, Owings, MD (US)

Correspondence Address: LARRY J. GUFFEY, WORLD TRADE CENER - SUITE 1800, 401 EAST PRATT STREET, BALTIMORE, MD, 21202, US

(21) Appl. No.: 11/254,930

(22) Filed: Oct. 20, 2005

Related U.S. Application Data
(60) Provisional application No. 60/620,621, filed on Oct. 20, 2004.

(51) Int. Cl. G06F 7/00

(52) U.S. Cl. 700/213

(57) ABSTRACT

The present invention provides a method and system for managing, within the constraints of an aviation system having defined resources, the operational assets of an airline for the transport of the passengers, luggage and cargo of the airline in such a manner as to allow the business and operational goals of the airline to be met to the highest degree possible. The steps of this method include: (a) collecting data on the status of the airline assets and those of the aviation system resources, (b) processing this data to predict the outcomes that will be achieved for the transport of the passengers, luggage and cargo, (c) processing the predicted outcomes to determine the degree to which the airline's goals are expected to be met as a result of the predicted outcomes, (d) identifying how this data would be feasibly changed so that its use to predict outcomes would yield results that give a higher degree of attainment of the airline's goals than that achieved by using the initially predicted outcomes, (e) processing these changes to identify the tasks that must be accomplished by the airline's assets so as to make the identified changed data applicable, and (f) developing instructions for the airline assets as to how they are to perform these tasks.

### CROSS-REFERENCE TO RELATED APPLICATIONS & PATENTS

This application claims the benefit of U.S. Provisional Patent Application No. 60/620,621, filed Oct. 20, 2004 by R. Michael Baiada and Lonnie H. Bowlin.

This application is related to the following U.S. patent documents: (USPAN) application Ser. No. 10/808,970 entitled “Method and System for Aircraft System Flow Management by Airlines/Aviation Authorities” and filed Mar. 25, 2004; U.S. patent application Ser. No. 10/913,062 entitled “Method and System For Tactical Gate Management By Aviation Entities” and filed Aug. 6, 2004, (USPN) U.S. Pat. No. 6,721,714, entitled “Method and System for Tactical Airline Management” which issued Apr. 13, 2004; U.S. Pat. No. 6,463,383, entitled “Method And System For Aircraft Flow Management By Airlines/Aviation Authorities” which issued Oct. 8, 2002, U.S. Pat. No. 6,789,011, entitled “Method And System For Allocating Aircraft Arrival/Departure Slot Times” which issued on Sep. 7, 2004, and U.S. Pat. No. 6,873,903, entitled “Method and System For Tracking and Prediction of Aircraft Trajectories” which issued on Mar. 29, 2005; all these documents having been submitted by or issued to the same applicants: R. Michael Baiada and Lonnie H. Bowlin. The teachings of these materials are incorporated herein by reference to the extent that they do not conflict with the teaching herein.

### BACKGROUND OF THE INVENTION

1. Field of the Invention

The present invention relates to methods and systems for tactically managing various airline functions and services from a system perspective so as to improve airline profitability.

2. Description of the Related Art

The need for and advantages of management operation systems that optimize complex, multi-dimensional, interdependent processes have long been recognized. Thus, many complex methods and optimization systems have been developed. For example, see U.S. Pat. Nos. 5,321,605, 5,369,570, 5,890,133 and 5,953,707.

However, as applied to management of the aviation industry, such methods often have been fragmentary or overly restrictive and have not addressed the overall optimization of an airline's operational functions. The reasons for this situation are complex and varied, but include considerations such as: the complex interdependence of the airlines and their use of shared airport facilities (i.e., common assets), extensive governmental regulations, the complex interdependence of the various internal airline functions, weather and the impact of the uncontrollable schedules of competitor's aircraft to name a few.

To better understand the airline processes, FIG. 1 has been provided to indicate the current airline passenger and cargo movement processes, which commences with passenger ticketing, followed by airport arrival, passenger loading, aircraft servicing (e.g., loading of fuel, food, and cargo) and ending after arrival at the terminal gate and delivery of baggage and cargo.

It is of interest to note that the core process within the airline industry is the movement of the aircraft. It moves off the gate, then works towards the next gate, is offloaded, serviced, loaded; only to move off the gate again. Since almost each of the airline's other processes key off of the movement of aircraft, the core elements of an airline can be thought of as being managed from the center out as depicted in FIG. 2.

Like most businesses, the various airlines are segmented into a number of distinct types of cost centers, business units or organizational entities. Although most airline processes are interdependent, current business practices within the airline industry promote the management of the individual assets independently by the individual asset managers without regard to an airline's overall system goal of maximizing profitability.

This has traditionally meant that actions by an individual cost center (e.g., pilot scheduling), although attempting to reduce its costs or increase its individual profit picture, can often have the effect of reducing an airline's overall profits, efficiency, effectiveness and product quality (e.g., cancelled flights because there are not enough pilots). There appear to be few current attempts by the various airlines to manage an airline from a more global or system perspective so as to make real time, tactical trade-offs between their business units and operational segments to maximize the airline's overall business and operational goals. These independent actions for each of the airline's assets, without regard to system effects, lead to considerable variance in the asset flows, which under conditions in the system is trying to operate at near capacity, can have very detrimental effects upon the productivity of the system (se FIG. 15).

Although many airlines currently have in place data on the positions of their assets (e.g., aircraft, passenger and baggage tracking systems) and the communications necessary to tactically manage these assets, they apparently lack the necessary business process and methods to utilize this data and these tools to tactically manage their assets in the most profitable manner. Instead, current business practices involve the use of much of this data to analyze operational errors or predict when various aircraft will arrive at the next gate.

Despite the above noted prior art, the need continues to exist for improved methods and systems for managing various airline functions and services to improve airline profitability.

3. Objects and Advantages

There has been summarized above, rather broadly, the prior art that is related to the present invention in order that the context of the present invention may be better understood and appreciated. In this regard, it is instructive to also consider the objects and advantages of the present invention.

It is an object of the present invention to provide a method and system which allows a user airline to better meet its business and operational goals.

It is another object of the present invention to provide a method and system which allows a user airline to: (1) predict the future trajectories of its assets, (2) identify potential problems with these trajectories (e.g., the aircraft trajectory does not 11 properly mesh with the passenger trajectory, gate trajectory or crew trajectory), (3) identify alternative trajectories which better meets the airline's business and operational goals, (4) implement these alternative trajectories and (5) continuously monitor the assets so as to identify any new potential problems with their trajectories.

Such a system should provide a user airline with the capabilities to:
a) continuously evaluate the current position and operational status of both airline controlled assets and those assets which the airline cannot control, but which impact the airline's operation,
b) predict the time each asset (controlled and uncontrolled) will reach a predetermined location,
c) assess the accuracy of inputted data and the predictions based on that data,
d) assess the impact of predicted trajectories on an airline's capabilities to meet its business and operational goals,
e) assess the workability of predicted trajectories relative to system capacities (runways, airspace constraints, gate availability, etc.),
f) build and analyze alternative scenarios to look for a solution set that better meets the business and operational goals of a user airline,
g) if required, display the chosen trajectory solution set to a system operator who can allow the present invention to operate automatically or manually accept/modify the proposed solution,
h) if required, coordinate the chosen trajectory solution set with other users/aviation authorities and seek authorization for use of the common assets,
i) communicate the assigned trajectories to each of the asset operators for each of the controlled assets,
j) continuously monitors the system to include the specified asset trajectories and other specified data and the airline's business and operational goals so as to identify any changes to the system or an action by one of the assets that prevents achievement of a assigned trajectory set, and
k) measures the airline's overall airline condition to determine if an updated solution set would better meet the operator's business and other goals.
l) implement and continuously monitor the updated trajectory solutions set as defined above.

It is therefore an object of the present invention to provide a method and system for managing specified airline assets from a system perspective so as to better achieve specified airline business and operational goals to overcome the limitations of the prior art described above.

It is another object of the present invention to present a method and system for the tactical management of an airline that takes into consideration a wider array of parameters and factors not heretofore considered. For example, such parameters and factors may include: passenger's itineraries and goals (i.e., smiling passenger at the destination curb, on time), aircraft related factors (e.g., speed, fuel, altitude, route, turbulence, winds, weather), ground services (e.g., passenger connections, maintenance, gate availability, passenger loading and deplaning, cargo, bags labor resources available), scheduling (e.g., seats availability, pricing), common asset availability (e.g., runways, airspace, ATC services) and competitors needs for use of the common assets (uncontrolled aircraft requiring access to the common assets, customs, etc.).

It is a yet another object of the present invention to provide a method and system that will enable an airline to increase profits and customer satisfaction, while reducing other risks and costs (i.e., increased quality and decreased costs—the best of both worlds).

It is a further object of the present invention to provide a method and system that will allow an airline to enhance its overall operating efficiency, even at the possible expense of its individual components that may become temporarily less effective. After an airline's overall operation is optimized, then, as a secondary task, the present invention tries to enhance the efficiency of an airline's individual components as long as they do not degrade the overall, optimized solution.

It is a still further object of the present invention to provide a method and system (process or operating model) that analyzes larger amounts of tactical information and other factors simultaneously, identifies system constraints and problems as early as possible and works to correct or mitigate those constraints with changes to the trajectories of the controlled assets.

It is still a further object of the present invention to temporally manage the flow of airline assets into or out of a specific system resource in real time to prevent that resource from becoming overloaded. Further, if the outcome of prior events puts demand for that system resource above capacity, it is then the object of the present invention to maximize the throughput of the now constrained system resource with a consistent, more optimally sequenced flow of assets to/from that system resource.

It is an additional object of the present invention to provide a method and system to tactically manage and control an airline's controlled assets to minimize the large temporal variations in asset flows (i.e., production variance) and mitigate variance, randomness and queuing, all of which represents a unique aspect of the present invention.

Such objects are different from the current art, which manages assets manually and independently with little regard for system effects, in a linear manner, or limits access to the entire system, not just the specific constrained system resource.

These and other objects and advantages of the present invention will become readily apparent as the invention is better understood by reference to the accompanying drawings and the detailed description that follows.

### SUMMARY OF THE INVENTION

The present invention is generally directed to satisfying the needs set forth above and overcoming the limitations and problems identified with prior methods for managing various airline functions and services.

In a general sense, the embodiment of the present invention is a business method for tactically managing an airline's operational assets from a system perspective so as to more profitably transport passengers, bags and cargo from the departure curb to the destination curb, as well as meet the operator airline's other business and operational goals.

In a first preferred embodiment, the present invention consists of a method for managing, within the constraints of an aviation system having defined resources, the operational assets of an airline for the transport of the passengers, luggage and cargo of the airline in such a manner as to allow the business and operational goals of the airline to be met to the highest degree possible. This method is based upon specified data pertaining to the airline assets, passengers, luggage, cargo and goals and the aviation system resources. It consists of the following steps: (a) collecting and storing data on the status of the airline assets, passengers, luggage and cargo and those of the aviation system resources, (b) processing the specified data and the status data to predict the outcomes that will be achieved for the transport of the passengers, luggage and cargo, (c) processing the predicted outcomes to determine the degree to which the airline's goals are expected to be met as a result of the predicted outcomes, (d) identifying for a future point in time how the most recent specified and status data would have to feasibly change so that if such changed data were to be applicable at said future point in time that its use to predict the outcomes would yield results for the transport of the passengers, luggage and cargo that give a higher degree of attainment of the airline's goals than that achieved by using the initially predicted outcomes, (e) processing these feasible changes to identify the tasks that must be accomplished by the airline's assets within the time period prior to the future point in time so as to make the identified changed data applicable at this future point in time, (f) when a portion of these tasks require coordination chosen from the group consisting of coordination for regulatory control or non-regulatory coordination with others outside of the airline, obtaining this coordination approval for the airline assets to perform these tasks, (g) developing instructions for the airline assets as to how they are to perform these tasks, and (h) communicating these instructions to the airline assets.

In a second preferred embodiment, this method further includes the steps of: (i) monitoring the progress of the assets towards accomplishing their tasks so as to identify when a situation arises that will prevent one or more of the tasks from being accomplished in a timely manner so as to prevent the achievement of the outcomes necessary for the higher degree of attainment of the airline's goals than that achieved by the initially predicted outcomes, and (j) when such a situation is identified, beginning again the steps of identifying new feasible changes, processing the new feasible changes to identify new tasks that must be accomplished by the airline assets, developing new instructions for performing the new tasks, and communicating the new instructions.

Examples of the specified data that is often used in this method includes: the temporally varying positions and trajectories of the aircraft and other vehicular assets and the mobile labor assets of the airline, the temporally varying weather conditions surrounding the aircraft and system resources, the flight handling characteristics of the aircraft, the safety regulations pertaining to the aircraft and system resources, and the position and capacity of the system resources.

In a third preferred embodiment, the present invention takes the form of a computer program product in a computer readable memory for allowing an airline to manage its operational assets for the transport of the passengers, luggage and cargo of the airline in such a manner as to allow the business and operational goals of the airline to be met to the highest degree possible. This product utilizes specified data pertaining to the airline assets, passengers, luggage, cargo and goals. It consists of the means for accomplishing each of the steps (a)-(j) listed above.

In a fourth preferred embodiment, the present invention takes the form of a system, including a processor, memory, display and input device, that allows an airline to manage its operational assets for the transport of its passengers, luggage and cargo in such a manner as to allow the airline's business and operational goals to be met to the highest degree possible.

Thus, there has been summarized above, rather broadly, the present invention in order that the detailed description that follows may be better understood and appreciated. There are, of course, additional features of the invention that will be described hereinafter and which will form the subject matter of the claims to this invention.

### BRIEF DESCRIPTION OF THE DRAWINGS

FIG. 1 illustrates the various steps and tasks necessary in the operation of an airline.

FIG. 2 illustrates many of the elements that must be managed by an airline as they are centered on the movement of aircraft.

FIG. 3 illustrates the decision steps involved in one embodiment of the method of present invention, which concerns meeting the airline's business and operational goals.

FIG. 4a-4b provides a more detailed, tabular description of the customers' needs and wants and the airline tasks/processes required to meet those needs and wants so as to meet the airline's business and operational goals.

FIG. 5a-5e provides a more detailed, tabular description of the decision making process to determine a more optimal gate arrival time for each aircraft, an important element within the present invention.

FIG. 6a-6d provides a flow diagram of one embodiment of the method of the present invention as it relates to the tactical management of the airline's primary production process—the aircraft trajectory.

FIG. 7 illustrates a typical arrival/departure flow from a busy airport.

FIG. 8 presents a depiction of the arrival/departure trombone method of sequencing aircraft.

FIG. 9 illustrates the decision steps involved in one embodiment of the method of present invention, which concerns the tactical management of the airline's aircraft.

FIG. 10 illustrates an airline's operations and identifies those tasks and resources associated with a particular aircraft and a preferred point of intervention of the present invention (***) in one embodiment of the present invention.

FIG. 11 illustrates a sample of the various types of data and a sample of a data flow that are used in one embodiment of the process of the present invention.

FIG. 12 illustrates the various computational processes that are associated with one embodiment of the process of the present invention, which concerns the tactical management of the airline's aircraft.

FIG. 13 illustrates some of the high level tasks that are currently being managed independently, if at all, in the operation of a typical airline.

FIG. 14 illustrates the primary interaction between one embodiment of the process of the present invention and the tasks shown in FIG. 13.

FIG. 15 illustrates the effects of variance, within an aircraft arrival flow to an airport, such that as demand nears capacity, queuing, and therefore delays increase.

FIG. 16 illustrates a representative Goal Function of the present invention for a single aircraft.

FIG. 17 provides a Table that illustrates the value of a representative Goal Function of the present invention for two aircraft.

FIG. 18 illustrates the data flow for a process to coordinate arrival fix times by multiple operators of the present invention.

FIG. 19 illustrates an example of a long trajectory of a single aircraft as used in the prediction process within the present invention.

FIG. 20 illustrates the difference between an unaltered aircraft arrival flow, an ATC managed aircraft arrival flow as seen in the current and an example of an optimized aircraft arrival flow as managed by the present invention.

### DEFINATIONS

ACARS—ARINC Communications Addressing and Reporting System. This is a discreet data link system between the aircraft and the airline. This provides very basic email capability between the aircraft and a limited set of personnel. Also provides access for the pilot to a limited set of operational data. Functionality from this data link source includes operational data, weather data, pilot to dispatcher communication, pilot to aviation authority communication, airport data, OOOI data, etc.

Aircraft Situational Data (ASD)—This an acronym for a real time data source (approximately 1 to 5 minute updates) provided by the world's aviation authorities, including the Federal Aviation Administration, comprising aircraft position and intent for the aircraft flying over the United States and beyond.

Aircraft Trajectory—The past, current and future movement or usage of an aircraft defined as a position and time (past, present or future). For example, the trajectory of an aircraft is depicted as a position, time and intent. This trajectory can include the airborne position, as well as taxi positions and even parking at a specified gate or parking spot.

Airline—a business entity engaged in the transportation of passengers, bags and cargo on an aircraft.

Airline Arrival Bank—A component of an airline's operation where numerous aircraft, owned by a single airline, arrive at a specific airport (hub airport) within in a very short time frame.

Airline Departure Bank—A component of an airline's operation where numerous aircraft, owned by a single airline, depart from a specific airport (hub airport) within a very short time frame.

Airline Gate—An parking area, spot, jetway or other structure where aircraft owners/airlines park their aircraft for the purpose of loading and unloading passengers, cargo, etc.

Air Traffic Control System (ATC)—A system to assure the safe separation of aircraft operated by an aviation regulatory authority. Typically, this is a government-controlled agency, but a recent trend is to privatize this function. In numerous countries, the Civil Aviation Authority (CAA) manages this system. In the United States the federal agency responsible for this task is the Federal Aviation Administration (FAA).

Arrival/Departure Times—Refers to the time an aircraft was, or will be at a certain point along its trajectory. While the arrival/departure time at the gate is commonly the main point of interest for most aviation entities and airline customers, the arrival/departure time referred to herein can refer to the arrival/departure time at or from any point along the aircraft's present or long trajectory.

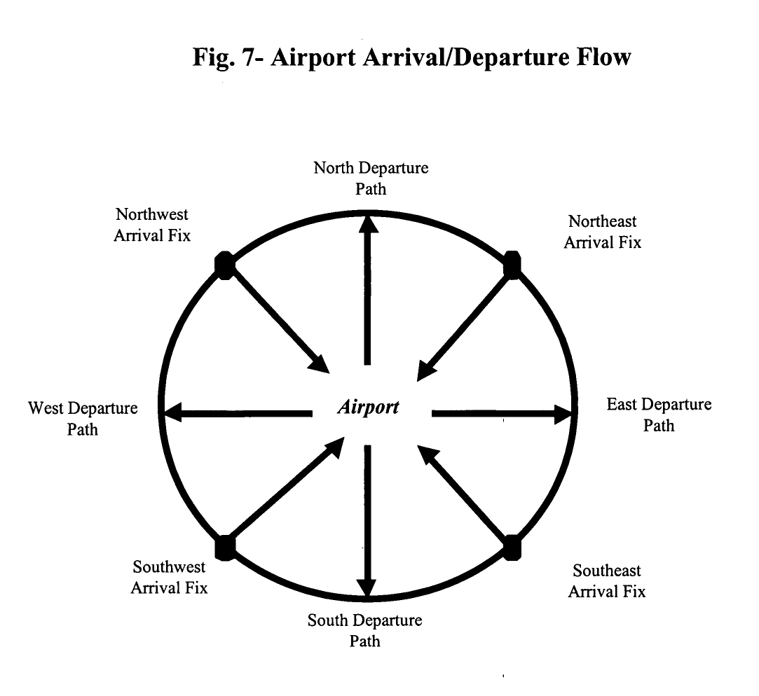

Arrival/departure fix/Cornerpost—At larger airports, the aviation regulatory authorities have instituted structured arrival/departure points that force all arrival/departure aircraft over geographic points (typically four for arrivals and four for departures, see FIG. 7). These are typically 30 to 50 miles from the arrival/departure airport and are separated by approximately 90 degrees. The purpose of these arrival/departure points or cornerposts is so that the controllers can better linearly sequence the aircraft, while keeping them separate from the other arrival/departure aircraft flows. With the use of the present invention, in the future it may be possible to move these merge points closer to the airport or even the runway end. As described herein, the arrival/departure cornerpost is the points where the aircraft merge. Additionally, besides an airport, as referred to herein, an arrival/departure fix/cornerpost can refer to entry/exit points to any system resource, e.g., a runway, an airport gate, a section of airspace, a CAA control sector, a section of the airport ramp, etc. Further, an arrival/departure fix/cornerpost can represent an arbitrary point in space where an aircraft is or will be at some past, present or future time.

Asset—To include assets such as aircraft, airports, runways, and airspace, flight jetway, gates, fuel trucks, lavatory trucks, and labor assets necessary to operate any and all of the aviation assets.

Asset Trajectory—The past, current and future movement or usage of any asset (i.e., aircraft, gate, personnel, equipment, etc.) as defined as a position, time (past, present or future). See Aircraft Trajectory.

Automatic Dependent Surveillance (ADS)—A data link surveillance system currently under development. This system, which is installed on the aircraft, captures the aircraft position from the onboard navigation system and then communicates it to the CAA/FAA, other aircraft, etc.

Aviation Authority—Also aviation regulatory authority. This is the agency responsible for aviation safety. In the US, this agency is the Federal Aviation Administration (FAA). In numerous other countries, it is referred to as the Civil Aviation Authority (CAA). As referred to herein, it can also mean an airport authority.

Block Time—The time from aircraft gate departure to aircraft gate arrival. This can be either scheduled block time (schedule departure time to scheduled arrival/departure time as posted in the airline schedule) or actual block time (time from when the aircraft door is closed and the brakes are released at the departure station until the brakes are set and the door is open at the arrival station).

CAA—Civil Aviation Authority. As used herein is meant to refer to any aviation authority responsible for aviation safety, including the FAA within the US.

Cooperative Decision-Making (CDM)—A program between FAA and the airlines wherein the airlines provide the FAA a more realistic real time schedule of their aircraft. For example if an airline cancels 20% of its flights into a hub because of bad weather, it would advise the FAA. In turn, the FAA compiles the data and redistributes it to all participating members.

Common Assets—Assets that must be utilized by the all airspace/airport/runway users and which are usually controlled by the aviation authority (e.g., CAA, FAA, airport). These assets (e.g., runways, ATC system, airspace, etc.) are not typically owned by any one airspace user.

Controlled Asset—An airline asset owned by, and or one that can be controlled by a particular airline. Controlled assets are ones that the airline can exercise a level of control as to its trajectory, movement, usage, and or other operational factors. An example of a controlled asset is an airline's aircraft.

CTAS—Center Tracon Automation System—This is a NASA developed set of tools (TMA, FAST, etc.) that seeks to temporally track and manage the flow of aircraft from approximately 150 miles from the airport to arrival/departure.

Federal Aviation Administration—The government agency responsible for the safety of the U.S. aviation system, including the safe separation of aircraft while they are in the air or on the ground within the United States.

Four-dimensional Path—The definition of the movement of an object in one or more of four dimensions—x, y, z and time.

Gate—An area where an aircraft parks to unload passengers, bags and cargo. Used herein, it can refer to a parking where a jetway or outside stairs, etc., is used to deplane and board the passengers. Additionally, this could be a parking area where the aircraft is left for an extended period of time, such as overnight.

Goal Function—a method or process of measurement of the degree of attainment for a set of specified goals. As further used herein, a optimization method or process to evaluate the current scenario against a set of specified goals, generate various alternative scenarios, with these alternative scenarios, along with the current scenario then being assessed with the goal attainment assessment process to identify which of these alternative scenarios will yield the highest degree of attainment for a set of specified goals. The purpose of the Goal function is to find a solution that “better” meets the specified goals (as defined by the operator) than the present condition and determine if it is worth (as defined by the operator) changing to the “better” condition/solution. This is always true, whether it is the initial run or one generated by the continuous monitoring system. In the case of the monitoring system (and this could even be set up for the initial condition/solution as well), it is triggered by some defined difference (as defined by the operator) between the how well the present condition meets the specified goals versus some “better” condition/solution found by the present invention. This can be done by assigning a “value” of how well a certain solution set meets the operator's goals. Once the Goal function finds a “better” or higher value condition/solution, that it determines is worth changing to, the present invention translates said “better” condition/solution into some doable task and then communicates this to the interested parties, and then monitors the new current condition to determine if any “better” condition/solution can be found and is worth changing again.

Hub Operation—An airline operating strategy whereby passengers from various cities (spokes) are funneled to an interchange point (hub) and connect with flights to various other cities. This allows the airlines to capture greater amounts of traffic flow to and from cities they serve, and offer smaller communities one-stop access to literally hundreds of nationwide and worldwide destinations.

IFR—Instrument Flight Rules. A set of flight rules wherein the pilot files a flight plan with the aviation authorities responsible for separation safety. Although this set of flight rules is based on instrument flying (e.g., the pilot references the aircraft instruments) when the pilot cannot see at night or in the clouds, the weather and the pilot's ability to see outside the aircraft are not a determining factors in IFR flying. When flying on an IFR flight plan, the aviation authority (e.g., ATC controller) is responsible for the separation of the aircraft.

Long Trajectory—The ability to look beyond the current flight segment to build the trajectory of an aircraft for x hours (typically 24) into the future. This forward looking, long trajectory may include numerous flight segments for an aircraft, with the taxi time and the time the aircraft is parked at the gate included in this trajectory. For example, given an aircraft's current position and other factors, it is predicted to land at ORD at 08:45, be at the gate at 08:52, depart the gate at 09:35, takeoff at 09:47 and land at DCA at 11:20 and be at the DCA gate at 11:31. At each point along this long trajectory, numerous factors can influences and change the trajectory. The more accurately the process can predict these factors, the more accurately the prediction of each event along the long trajectory. Further, within the present invention, the long trajectory is used to predict the location of an aircraft at any point x hours into the future.

OOOI—A specific aviation data set (Out, Off, On and In) comprised of; when the aircraft departs the gate (Out), takes off (Off), lands (On), and arrives at the gate (In). These times are typically automatically sent to the airline via the ACARS data link, but could be collected in any number of ways.

PASSUR—A passive surveillance system usually installed at the operations centers at the hub airport by the hub airline. This proprietary device allows the airline's operational people on the ground to display the airborne aircraft in the vicinity (up to approximately 150 miles) of the airport where it is installed. This system has a local capability to predict landing times based on the current flow of aircraft, thus incorporating a small aspect of the ATC prediction.

Strategic Tracking—The use of long-range information (current time up to “x” hours into the future, where “x” is defined by the operator of the present invention, typically 24 hours) to determine demand and certain choke points in the aviation system along with other pertinent data as this information relates to the 11 trajectory of each aircraft, gate, etc.

System Resource—a resource like an airport, runway, gate, ramp area, or section of airspace, etc, that is used by all assets, (e.g., aircraft). A constrained system resource is one where demand for that resource exceeds capacity. This may be an airport with 70 aircraft that want to land in a single hour, with arrival/departure capacity of 50 aircraft per hour. Or it could be an airport with 2 aircraft wanting to land at the same exact time, with capacity of only 1 arrival/departure at a time. Or it could be a hole in a long line of thunderstorms that many aircraft want to utilize. Additionally, this can represent a group or set of system resources that can be track and predicted simultaneously. For example, an arrival/departure cornerpost, runaway and gate represent a set of system resources that can be track and predictions made as a combined set of resources to better predict the arrival/departure times of aircraft.

Tactical Tracking—The use of real time information (current time up to “n1” minutes into the future, where “n1” is defined by the operator of the present invention, typically 1 to 5 hours) to predict asset trajectories.

Trajectory—See aircraft trajectory and four-dimensional path above.

VFR—Visual Flight Rules. A set of flight rules wherein the pilot may or may not file a flight plan with the aviation authorities responsible for separation safety. This set of flight rules is based on visual flying (e.g., the pilot references visual cues outside the aircraft) and the pilot must be able to see and cannot fly in the clouds. When flying on a VFR flight plan, the pilot is responsible for the separation of the aircraft when it moves.

Uncontrolled Asset—An asset that is not owned by, and or one that cannot be controlled by a user airline. Uncontrolled assets are ones that the user airline cannot exercise any level of direct control as to movement, usage, and or other operational factors. An example of an uncontrolled asset is an airline's competitor's aircraft.

User Airline—The term user airline and airline be will be used interchangeably to denote an airline utilizing the present invention for enhancing its operational effectiveness and efficiency.

### DESCRIPTION OF THE PREFERRED EMBODIMENT

Before explaining at least one embodiment of the present invention in detail, it is to be understood that the invention is not limited in its application to the details of construction and to the arrangements of the method steps set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Referring now to the drawings wherein are shown preferred embodiments and wherein like reference numerals designate like elements throughout, there is shown in these figures many of the steps involved in various embodiments of the present invention.

As previously mentioned, a preferred embodiment of the present invention takes the form of a method that effectively manages the assets of a user airline, based upon consideration of data regarding the status and needs of the user airline assets and passengers, the assets of competitor airlines, common shared assets, aircraft positions and the weather, etc., to achieve specified business and operational goals of the user airline. The overall goal of this method is to increase airline profitability through the tactical management of an airline's assets from a system perspective. It is important to note that the present invention is in some ways the combination of a group of business management processes. Within the present invention, these processes work cooperatively to improve the airline's asset productivity and product quality, while decreasing costs, thus improving profitability. These processes include:
1. A four-dimensional (4D, i.e., three spatial directions and time) asset tracking process that looks at data on the current status (position and trajectory) of as many assets as possible (controlled and uncontrolled), while also assessing the accuracy of this data,
2. A look ahead and predicative process for the specified assets (i.e., long trajectory as defined herein),
3. An initial goal function process that determines the “value” of the current airline condition (i.e., how the current asset trajectories mesh in the future) based on the airline's business and operational goals by dynamically combining the business and operational goals of the user airline, the predicated trajectories and demands of the airline's assets, the airline competitor's assets on the user airline and the common assets (i.e., runways, ATC system assets, airspace, etc.), known constraints, the current asset status and capabilities, the knowledge provided from the asset tracking and prediction processes, etc.;
4. A subsequent goal function process that generates and looks at numerous alternative solutions and their values, chooses one solution that suggests realistic trajectory modifications (target trajectory for each asset) to the current trajectory of the controlled assets to improve the predicted and actual outcome in relation to the airline's business and operational goals;
5. A coordination process, if required, that seeks approval/authorization of the targeted trajectories for use of the common assets and assigns trajectories once approval/authorization is gained;
6. A communication process that notifies each asset manager of his or her assigned trajectory, and
7. An ongoing monitoring process, which continually monitors the current state of the system before and after the combination of the above parts of the process have been exercised. This monitoring process measures the current state of the assets against their ability to meet the assigned trajectory. If at such time actions by one of the assets, controlled or uncontrolled, or changes to any other real time elements of the specified data would preclude the meeting of the assigned trajectory or the business and operational goals, or the airline's business or operational goals change, the system operator can be notified, and/or the process automatically starts anew.

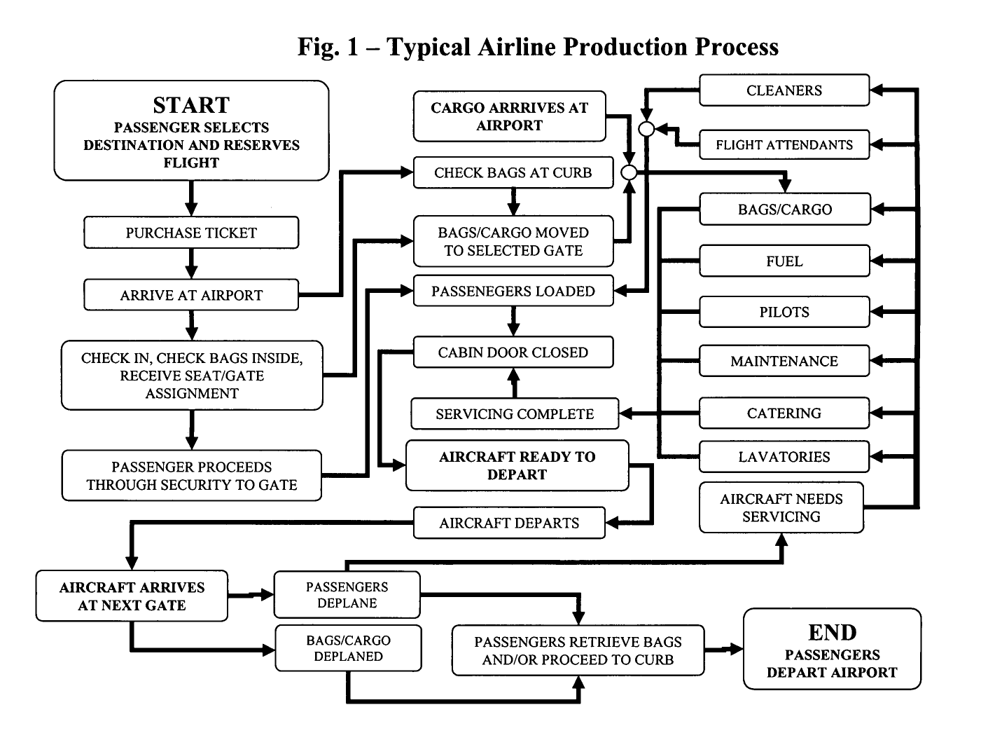

As depicted in FIG. 1, an airline's operations may be considered as a stepwise process that starts when the passenger selects a destination and books a flight. A ticket is purchased. The passenger, arriving at the airport, may check bags or luggage at the curb or inside; checks in and receives a seat and gate assignment; and then proceeds through security to gate and then check in. During this time cargo arrives at the airport.

Passengers are loaded into airplane after the cleaners complete their tasks and flight attendants arrive. Meanwhile, aircraft servicing is underway. This includes: loading bags, cargo, food, and fuel; arrival of pilots; completion of maintenance activities; servicing lavatories; and completion of other necessary services.

Just before departure, the aircraft's cabin door is secured. Once all other servicing is complete the aircraft is ready to depart. The aircraft departs the gate and taxis to the runway. It then takes off and flies to the destination. Upon landing the aircraft must taxi to the arrival gate. Arriving at the destination gate the passengers depart, bags and cargo are deplaned; and passengers retrieve bags and/or proceed to the curb ready to depart the airport.

As can be seen within, the present invention works from a system perspective so as to better mesh all of the interdependent processes and assets in real time to bring all of the airline's assets to the right place, closer to or at the right time to better meet the user airline's operational and other goals.

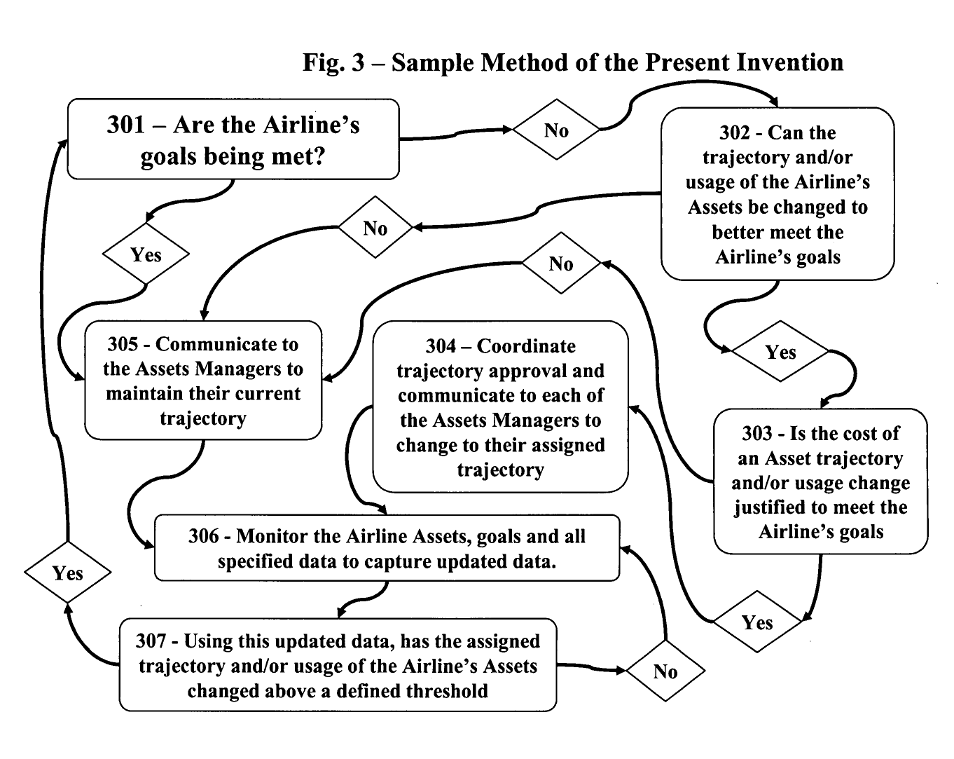

FIG. 3 provides a flow diagram that represents the high-level decision steps involved in the control of the assets in one embodiment of the present invention. It denotes (step 301) how the present invention must first determine if the airline's goals are being met. In step 302, this method is seen to evaluate all of the trajectories of an airline's assets to determine if changes to these trajectories would yield a solution where more of the airline's business and operational goals would be fulfilled. If this cannot be done, this method involves communicating the current trajectories to the asset managers (step 305).

If modifications to the trajectories of the airline's assets can produce a better match to the airline's business and operational goals, the cost of these changes must be compared to the benefit produced (step 303). If the cost does not justify the changes to the trajectory, the process must default to step 305 once again.

Conversely, if the cost of modifications to one or more of the trajectories of the airline's assets is lower then the benefit produced, the method then entails communicating the targeted trajectories to the an approval/authorization agency for approval/authorization as required. Once a new trajectory set is found and approval/authorization gained to implement these new trajectories, the present invention then communicates these assigned trajectories to the individual airline asset managers (step 304).

Finally, the method involves monitoring the assets to determine if each of the airline's assets will meet their current/new trajectory goal (step 306). This method continuously analyzes the controlled and uncontrolled airline assets from present time up to “n” hours into the future, where “n” as defined by the user airline to measure the goal function value of the current condition and seek a trajectory set that provides a higher goal function value (i.e., the process is continuous). Then, as seen in FIG. 307, if the assigned trajectory and/or usage of the Airline's Assets changes above a defined threshold, the process is started anew. In one embodiment of the present invention, the overall time frame for each analysis is typically twenty-four hours.

Thus, this method is seen to avoid the pitfall of sub-optimizing particular parameters. Fuel burn, for instance, is not optimized at the expense of missing large numbers of connecting flights. This method accomplishes this by assigning values to each of the goal function variables (by the operator airline) so that the correct business trade-off is made to insure the higher profitability level.

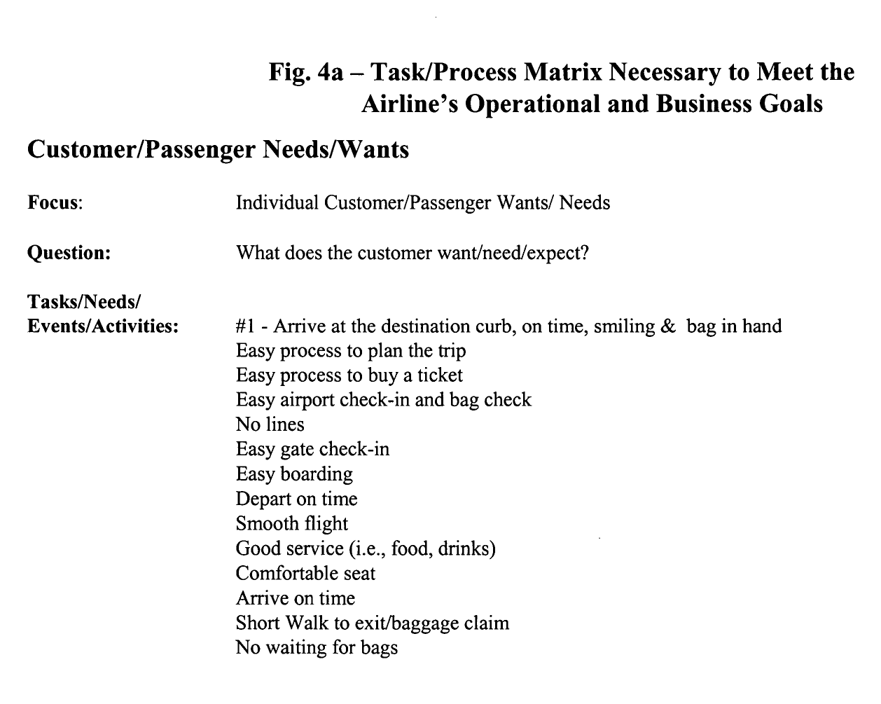

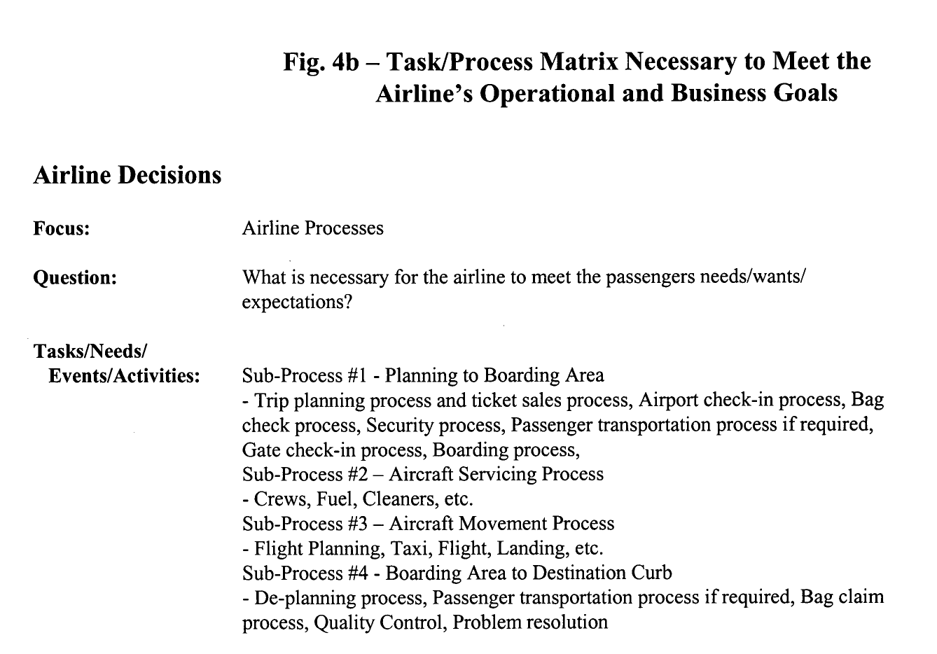

While the present invention is capable of providing a linear solution to the process, it is recognized that a multi-dimensional solution capable of managing all of the interdependent assets and their trajectories simultaneously provides a better, more profitable solution. Additionally, while it is recognized that the present invention manages the airline's assets (linearly, multi-dimensionally, or both) as a system, for ease of understanding and implementation, the described implementation of the present invention contained herein separates the overall system optimization into the four sub-processes (see FIG. 4b) described below:

Sub-Process #1—Passenger departure processes to include: travel planning, ticket purchase, arrival at the departure curb, bag check, check-in, security checks and movement to the aircraft boarding/loading area,

Sub-Process #2—Aircraft gate processes to include: aircraft servicing (cleaning, fueling, cargo/bag loading, maintenance, etc.), passenger boarding,

Sub-Process #3—Aircraft movement processes (pushback, taxi, departure, takeoff, enroute, arrival, landing, taxi), and

Sub-Process #4—Passenger arrival processes to include: deplaning, departure of the aircraft boarding/loading area, movement to the baggage claim and/or departure area, baggage claim, movement to the destination curb and problem resolution process.

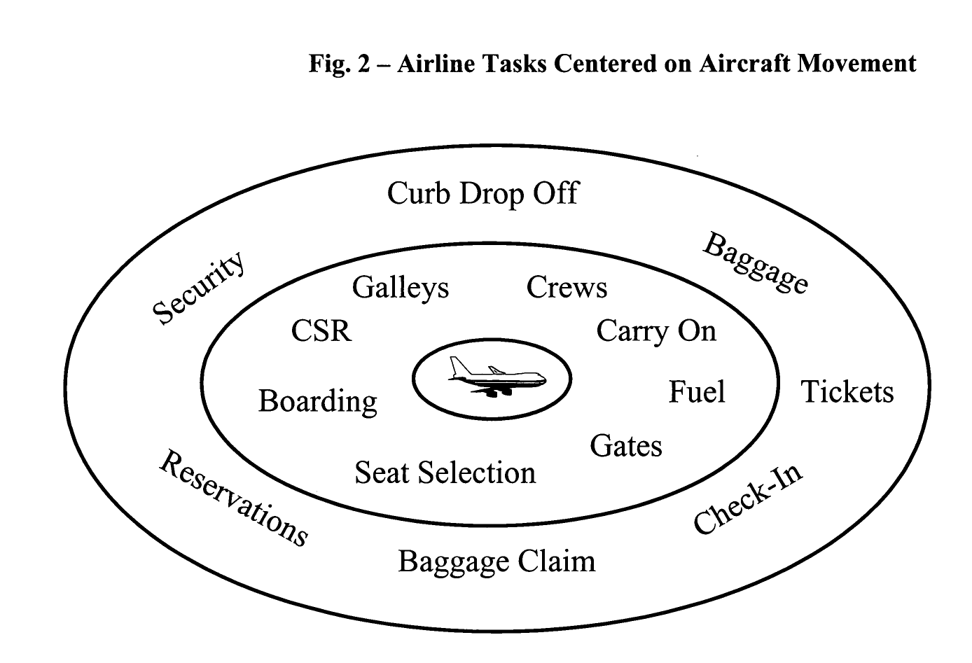

Additionally, since it is recognized that in most embodiments of the present invention the aircraft process will be seen as the key element of the overall airline process (see FIG. 2), it is felt that the optimization of the movement of the aircraft will be chosen by most operators as the primary point of optimization.

In other words, while some operators may chose another optimization hierarchy, it is felt that since almost all airline operational functions key off of the movement of the aircraft, most embodiments of the present invention will optimize the aircraft first and then work to optimize the other controlled assets to the aircraft. In addition, since from a structural perspective, the trajectory modification process in all of these sub-processes is similar, regardless of the optimization hierarchy of these sub-processes, only Sub-Process #3 (Aircraft Movement Process) is described below in detail.

Next, since the implementation of the present invention uses a multi-dimensional solution that evaluates numerous parameters simultaneously (as opposed to a linear implementation that sequentially evaluates single parameters one at a time), the standard yes-no flow chart is difficult to construct. Therefore, tables have been included to better depict the implementation of the present invention.

FIG. 4a-4b provides a tabular description of the task/process matrix required to meet an airline's business and operational goals. FIG. 4a is seen to involve a number of parameters that outline a customer's needs and/or wants. FIG. 4b illustrates the processes necessary to meet the customer's needs/wants/expectations broken down into the sub-processes required.

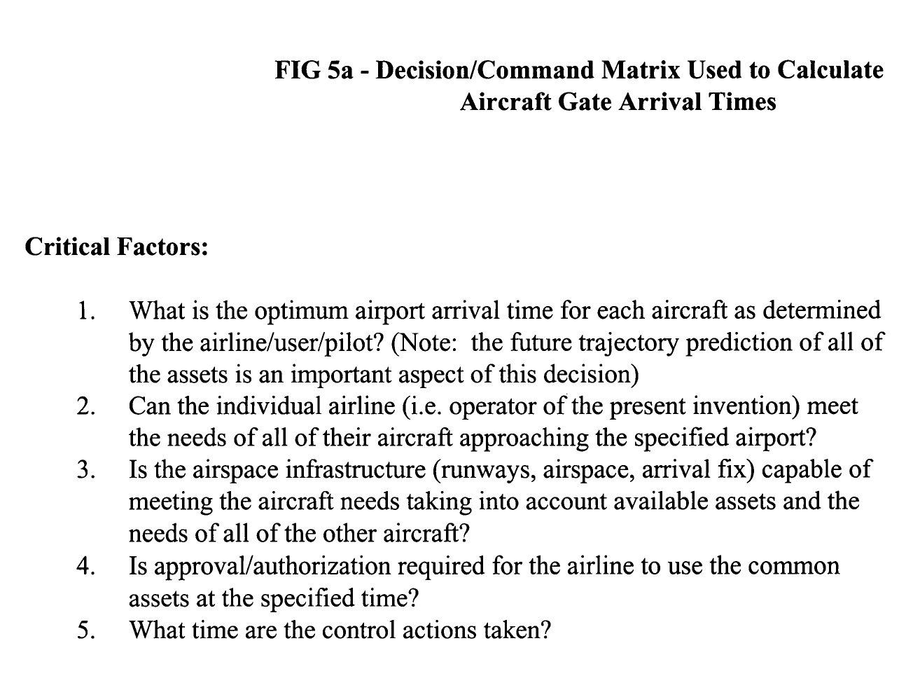

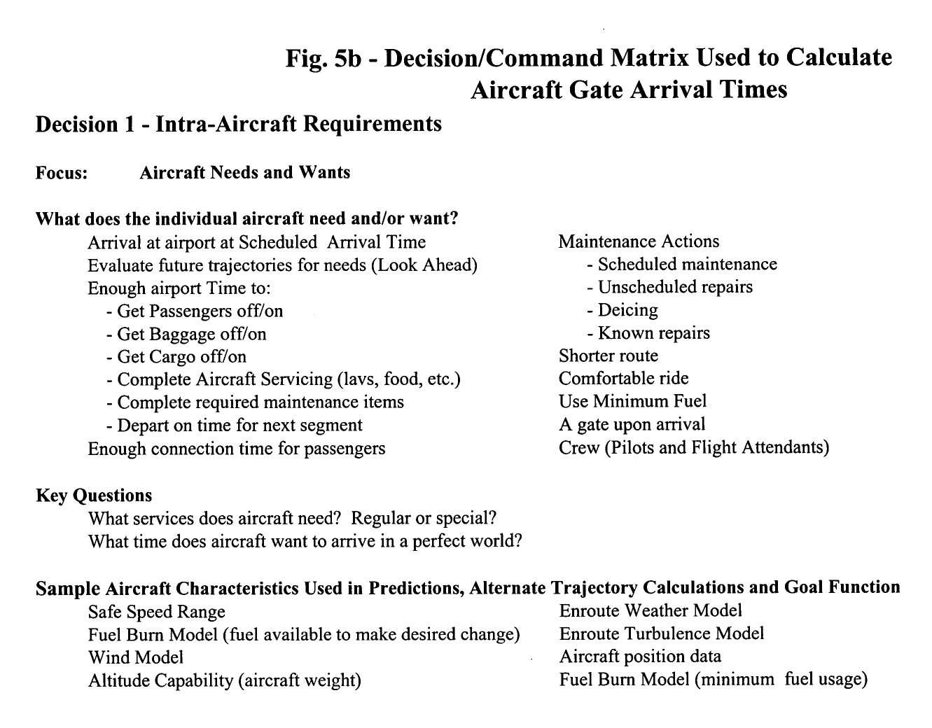

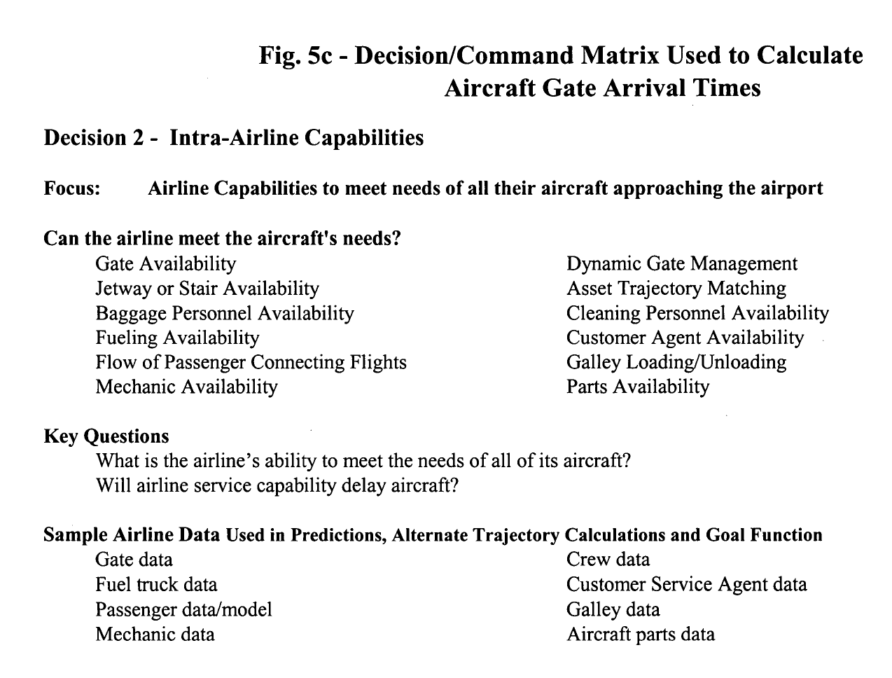

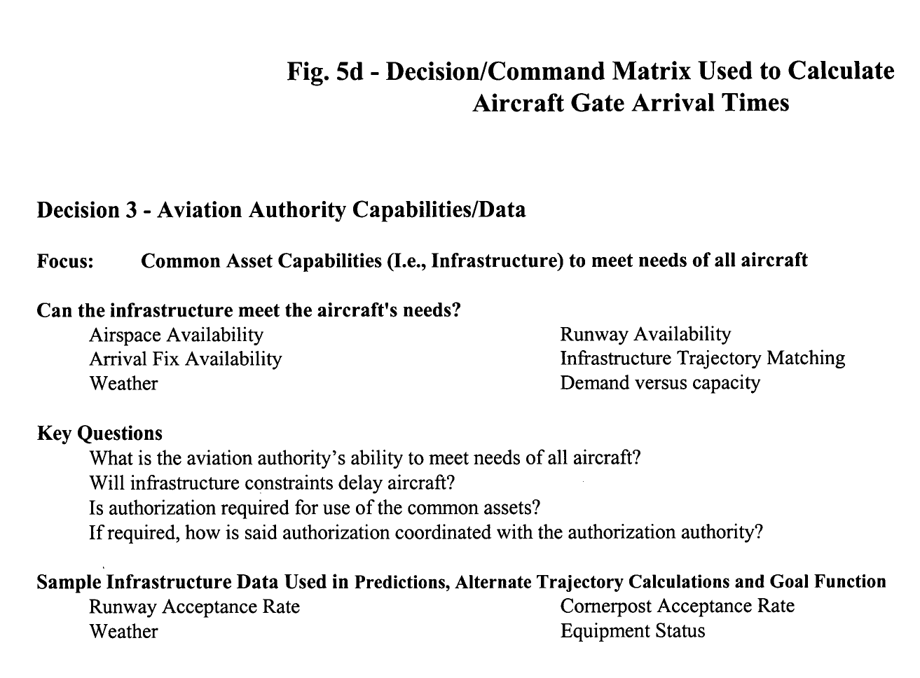

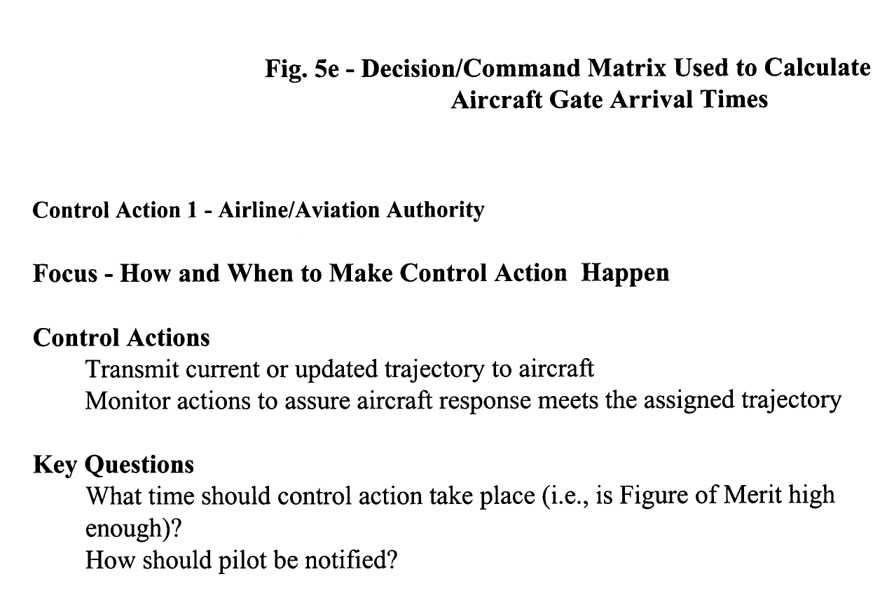

FIG. 5 provides a more detailed, tabular description of sub-process #3: the Aircraft movement process, and specifically, the task of determining a more optimum arrival time of each controlled aircraft asset. It describes the order of the decision making process within the implementation of one embodiment of the present invention.

Decision 1—Tactical Intra-Aircraft Decisions (FIG. 5b), involves determining the aircraft's needs and/or wants. Each of the individual aircraft's needs and/or wants must be evaluated and balanced against the individual aircraft's other needs and/or wants.

For example, the need to arrive on time must be balanced against the required gate time to assure all of the gate functions can be accomplished to assure the next on-time departure, while evaluating the need to use minimum fuel to reduce costs.

For example, if a flight is delayed at the departure station (for any number of reasons) for five minutes, but also needs to arrive four minutes early to assure the next departure, absence modifications to the aircraft trajectory, the flight will be nine minutes behind its preferred trajectory.

Current business management practices within the airline industry do not provide for this required nine minute correction on a system basis, except for block time increases in the system schedule (a strategic process with a three to six month lead-time) or possible independent actions by individual pilots. Therefore, this hypothetical flight would arrive five minutes late, and then depart again nine minutes late.

However, as shown in FIG. 5b, Decision 1, the present invention would evaluate that selected flight's ability to speed up based on fuel availability, ride conditions, etc., to determine if aircraft trajectory modifications are possible and desirable.

As can be seen in FIG. 5b, Decision 1, upwards of twenty aircraft parameters must be balanced simultaneously to maximize the efficiency of the aircraft. This is quite different than current business practices within the airline industry which usually focus decision making on a very limited data set, i.e., scheduled on-time arrival, and possibly one other parameter—fuel burn, if any at all. Additionally, the current business practice typically will only look at a local optimization (e.g., fuel usage) without regard to the total system optimization.

This embodiment of the present invention recognizes that the tactical requirements of each of the listed parameters has an effect on the real-time decision of what time the aircraft should arrive at the gate. However, it should be noted that the decision-making process represented in Decision 1 (FIG. 5b) is only evaluating the aircraft arrival time in a perfect world—no weather, no other aircraft interferences, no external constraints to the aircraft trajectory. This unrealistic situation is addressed in the later stages of the decision-making process.

To illustrate how this is accomplished, let's assume that using the FIG. 5b, Decision 1 process, a flight wants to arrive at a gate 25 at 08:10 AM. Once the perfect world, optimal gate arrival time has been determined for each aircraft of an airline, the next step is to evaluate the user airline's ability to meet the needs and/or wants of the individual aircraft. This is done at the step illustrated in FIG. 5c, Decision 2—Tactical Intra-Airline Decisions. Here, this decision making process evaluates the airline's ability to meet the needs of each individual aircraft, while also considering their possible interactions with; and needs/wants of the user airline's other aircraft and those of its competitor's aircraft that are approaching the same particular airport.

It can be noted that this step is made more difficult because of the airlines' desires to run hub operations. Such hub operations typically schedule thirty to sixty of the user airline's aircraft to arrive at a single airport in a very short period of time. The aircraft then exchange passengers, are serviced and then take off again. The departing aircraft are also scheduled to takeoff in a very short period of time. Typical hub operations are one to one and a half hours in duration and are repeated at the hub airport eight to twelve times per day.

Thus, such hub operation put a larger burden on the ground assets of an airline, almost guaranteeing that the individual actions taken by asset managers without regard to system optimization will degrade the operational outcome. In other words, although the airline hub process is not designed to fail, the present art of local optimization of the individual components of the random, inter-dependant asset flows assures that the hub process fails all too often.

Further, the lack of system optimization of this multi-dimensional, interdependent, hub arrival and departure system almost assures a “Ping-Pong” or ripple effect as is seen in the airline industry today (wherein the terms “Ping-Pong” and “ripple effect” are understood to mean that an action by one unit within a interdependent, multi-dimensional system has an unintentional, and often detrimental, effect on another unit within that same system).

For the hypothetical flight that wants to be at gate 25 at 08:10 AM, let's further assume that at 06:10 AM, it is recognized that the aircraft preceding this fight is late and will not arrive on gate 25 until 07:45 AM, and will be on gate 25 until 08:15 AM. Rather than delay the arrival of our 08:10 flight, a possible better choice would be to direct this flight into another gate, but, in this example, let's further assume that, because of the hub operation, all other gates are scheduled to be used until at least 08:20 AM. Given the airline's inability to meet the 08:10 flight's need for a gate at 08:10 AM, the best available solution may be to slow the flight down to save fuel. Thus, after the airline's ability to meet the aircraft's needs and/or wants is added to the solution, this process recommends that the decision be made to change the flight's gate arrival time from 08:10 AM to 08:15 AM.

However, the decision-making process is not complete, as shown in FIG. 5d, Decision 3, to “Tactical External Airline Decisions.” These parameters are typically not under the direct control of the airline. An example of an external constraint is the airport landing rate.

Building on the above example, let's further assume that the hub arrival airport can typically land seventy-eight aircraft per hour, but because of low visibility weather conditions, this number has been reduced to sixty-two landings per hour. Because of this external constraint, this embodiment of the present invention decision making process must evaluate changing the trajectories of the controlled arrival aircraft to meet the external constraint of sixty-two landings per hour, while still meeting, as best as possible, the parameters in the FIGS. 5b and 5c, Decision 1 and 2 steps.

Thus, it is probable that this external constraint will result in the decision being made to speed-up some aircraft in order to meet earlier arrival times, while others are slowed down. As a result of this Decision 3 step (FIG. 5d), let's further assume that the trajectory of the hypothetical flight is changed so that the flight is now given a final gate arrival time of 08:26 AM.

A unique aspect of this embodiment of the present invention is that it provides a means to now convert this new gate time to a manageable control action that can be carried out by the asset managers (the pilots in the case of the aircraft)—speeding-up or slowing-down, as necessary, to arrive at the new gate time and consequently a new cornerpost arrival time (FIG. 5e).

It is further recognized that the optimization of the aircraft flow is only one aspect of the present invention. To better meet the system operator's goals, the present invention must also analyze and modify the trajectories of the user airline's other assets.

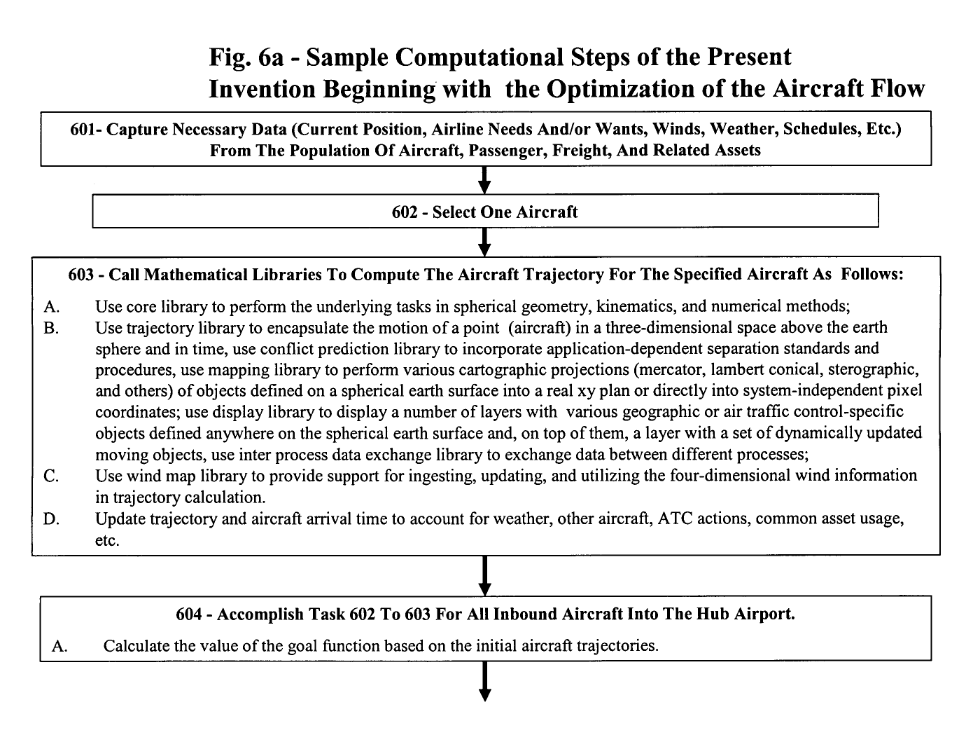

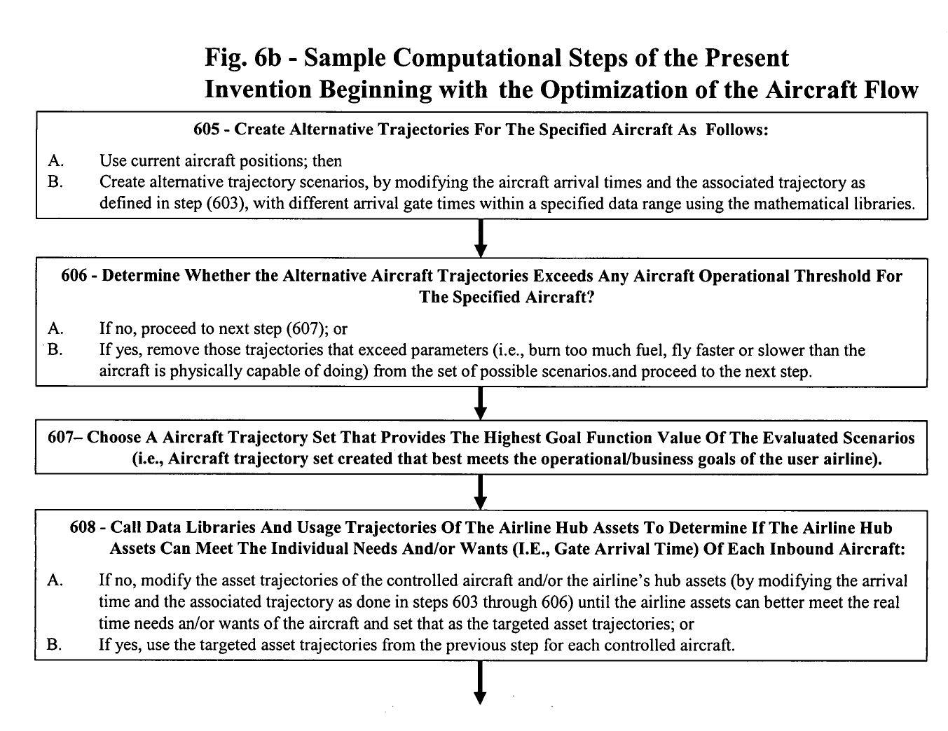

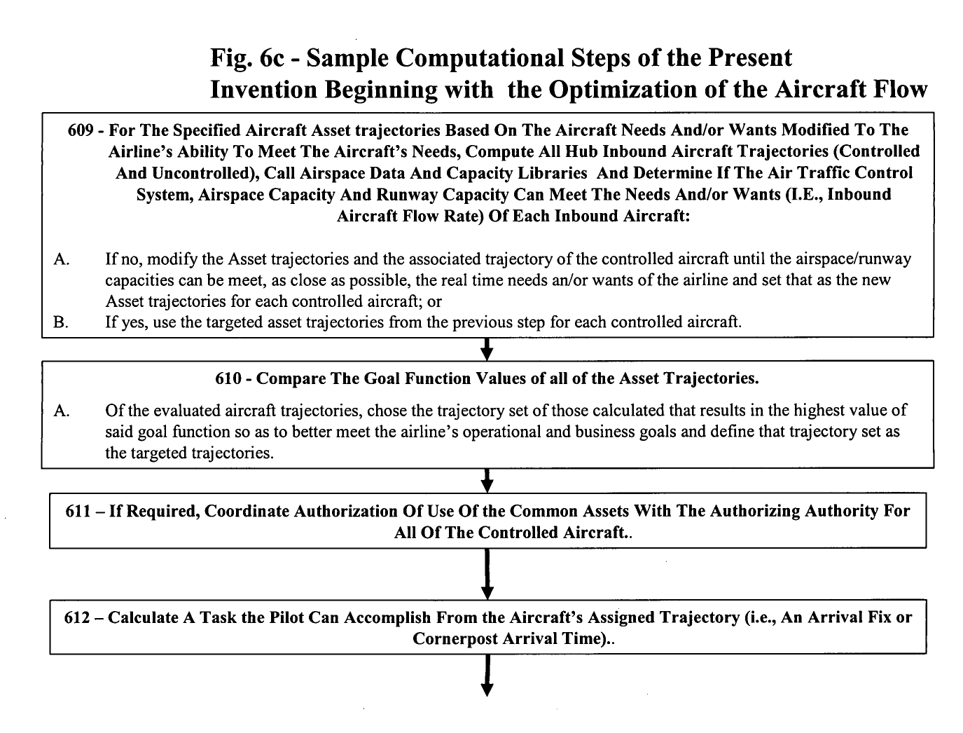

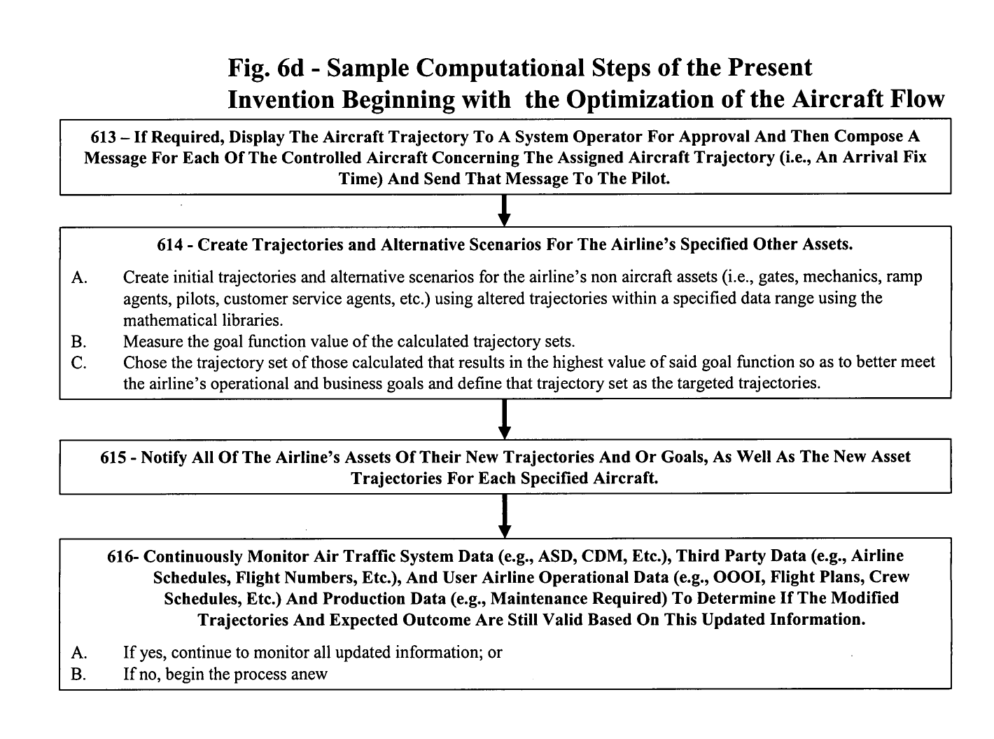

This decision making process is further illustrated in FIG. 6a-6d, where we see a representative flow diagram of the decision making or computational steps taken in the process described above. Again, although any asset trajectory (i.e., gate, cleaners, pilots, etc.) could be chosen for this example, the aircraft example has again been chosen as the primary process for optimization. In step 601, data is captured from the population of aircraft, passenger, freight, and related assets. These data sets are obtained as a prelude for the various actions and processes intended to optimize the airline's performance to better meet the user airline's goals.

In step 602, one aircraft is selected to optimize. While in reality, the selection of the first aircraft, and the next and the next could be arbitrary; one method of selection could be based on the aircraft closest to the arrival airport

In step 603, the unaltered trajectory of the selected aircraft is calculated. This process is used to determine, for each of the monitored assets, the predicted outcome of an unaltered trajectory.

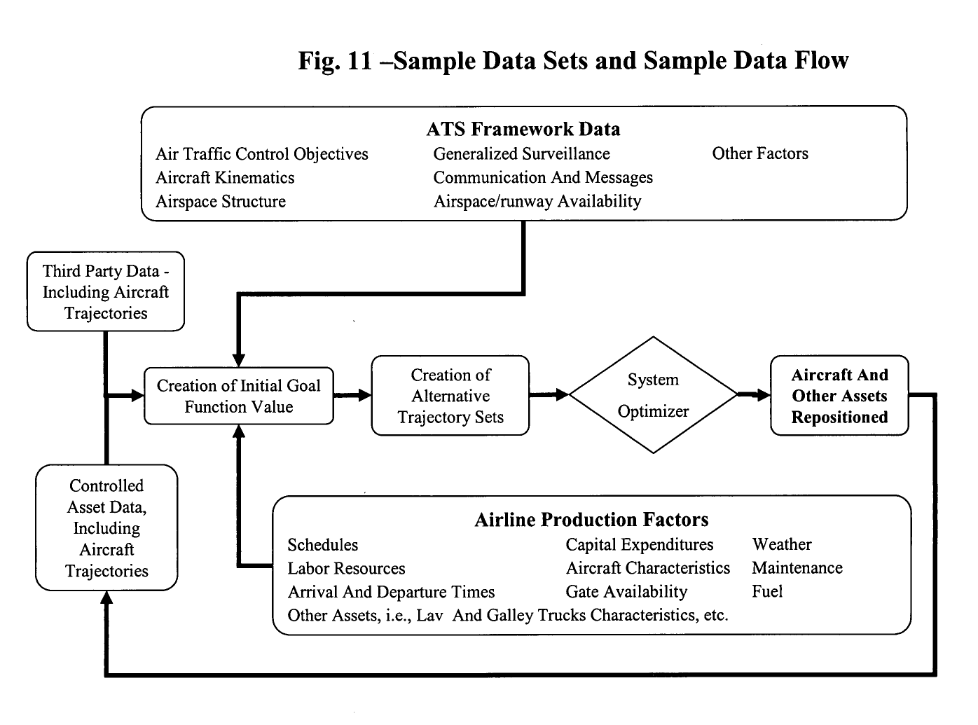

The data for input into this process comes from a number of sources, including: Automatic Dependent Surveillance (ADS), FAA's Aircraft Situational Data (ASD), airline operation's computers, gate system computers, and other data sources to determine the trajectories of as many of the specified assets as possible. A sample of the possible data sources can be seen in FIG. 11. After the data concerning each aircraft and/or asset is collected, readily available computer programs (e.g., “Aeralib,” from Aerospace Engineering & Associates, Landover, Md.) are used to generate the various trajectories.

In step 604, the trajectory prediction process is repeated for each arrival aircraft and the initial value of the goal function is calculated.

In step 605, the operational requirements for the selected aircraft (e.g., on-time requirement, gate requirement, ground service required, passenger connections, crew legality, ramp service requirements, maintenance, customs, etc.) are used to create alternative flight scenarios (trajectories). In step 606, each trajectory is evaluated to assure that it does not exceed the operational limits of the aircraft (e.g., since it requires additional fuel to speed up to arrive early, the aircraft must have the additional fuel necessary to perform the modification called for by the present invention). Those trajectories that exceed operational parameters (as defined by the operator) are removed from the set of alternative scenarios to be evaluated. For example, a trajectory that requires the aircraft to fly faster or slower than physically possible is discarded. This assures that each alternative scenario that is to be further evaluated represents a realistic set of options for the assets involved.

In step 607, using a readily available computer optimization process (i.e., CPLEX from Ilog or Xpress-MP from Dash Optimization) modified to optimize aircraft flows, each scenario is compared to the other possible trajectory sets to identify a scenario, which better meets the aircraft's needs and/or wants. Once this scenario is selected, the flight's associated gate arrival time is tentatively set.

In step 608, these targeted trajectories are used to determine if the airlines other assets and sub-processes can meet the needs and/or wants of each aircraft (e.g., it is of little value to move an aircraft ahead in time if a gate will not be available). If all of the aircraft's needs and/or wants can be met (an unlikely scenario), the tentative trajectories are carried forward to the next step.

If the airlines other assets and sub-processes cannot meet all of the needs and/or wants of each aircraft, still more alternative trajectories are created for each of individual aircraft and other assets.

Step 609 is somewhat analogous to step 608, whereas in step 608 this process involved evaluating the airline's hub capabilities, step 609 involves evaluating the external airspace/runway capabilities (i.e., common assets) to meet an aircraft's needs and/or wants as modified by 608. Alternative trajectories are again evaluated for the aircraft in relation to common asset constraints while searching for a set of aircraft trajectories that better meets the airline's business and operational goals.

For example, simply because all of the aircraft want to arrive on time and the airline can handle them all on time (i.e., gates and personnel available); it doesn't mean that it is physically possible to do so given the runways available. Imagine a snowstorm that cuts airport arrival capacity by 50%. Obviously, some of the aircraft must be slowed down.

The process of this embodiment of the present invention strives to find a asset trajectory set that slows down those aircraft that may not have gates or fewer passenger connections, etc. or speeds up aircraft to arrive early that have gates available. Once a set of gate arrival times is found that better meets the airline's business and operational goals, these new, optimized gate arrival times over-ride the prior, tentative gate arrival times.

In step 610, using the aforementioned goal optimization process, it can be seen that the present invention seeks the trajectory set that better meets the airline's business and operational goals.

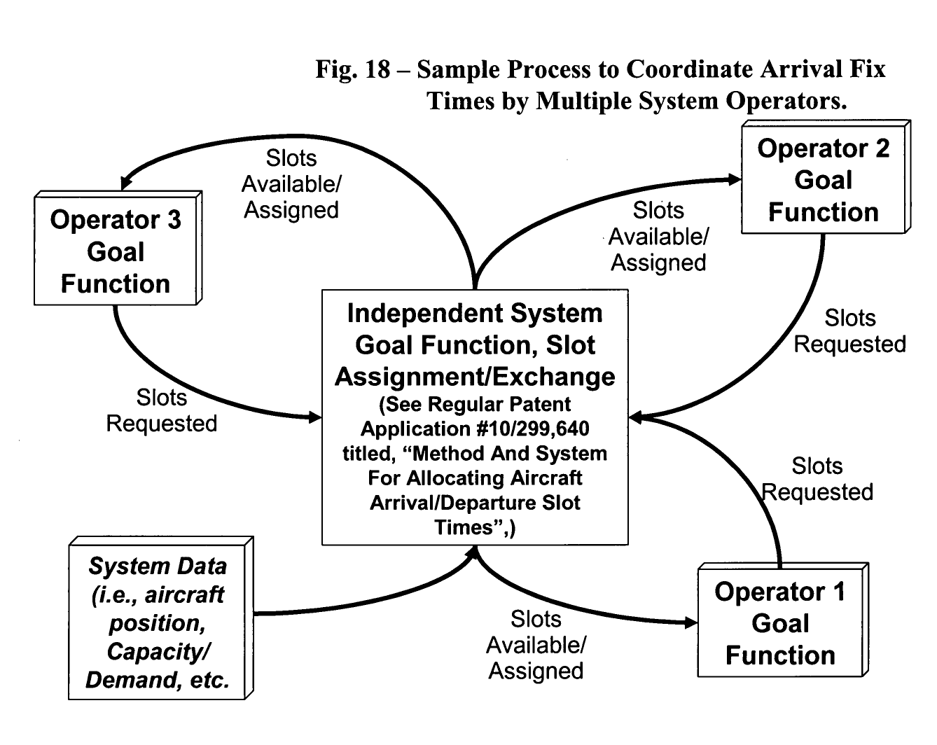

Then, in step 611, approval/authorization of the targeted aircraft trajectories is coordinated with an approval/authorization agency (see FIG. 18), as required.

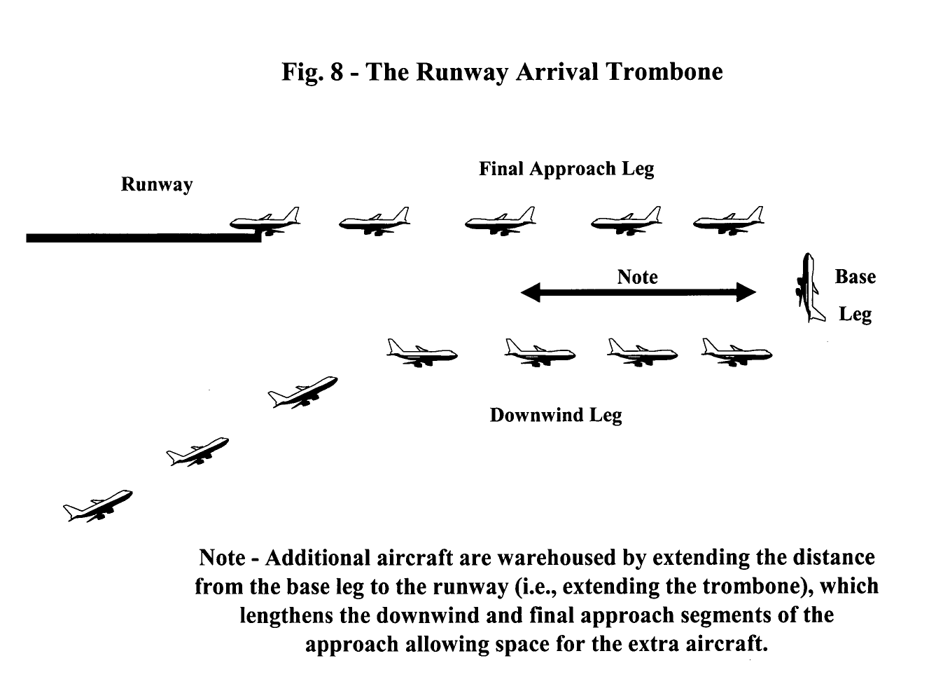

In step 612, the gate arrival times then are converted into corresponding cornerpost arrival times. The reason this is done is to provide the pilot an arrival fix or cornerpost time rather than a gate arrival time is a function of the current Air Traffic Control procedures. For example, current CAA practices for managing arrivals at arrival airports involve sequencing aircraft arrivals by linearizing an airport's traffic flow according to very structured, three-dimensional, aircraft arrival paths, 100 to 200 miles from the airport or by holding incoming aircraft at their departure airports. For a large hub airport (e.g., Chicago, Dallas, Atlanta), these paths involve specific geographic points that are separated by approximately ninety degrees; see FIG. 7. Additionally, because of the vectoring and other actions taken by the ATC controller after the cornerpost arrival fix (see FIG. 8), it is difficult for the pilot to calculate and manage a gate arrival time. The purpose of the arrival fix or cornerpost time is to provide the pilot a task that can be accomplished.

Using the example above, the hypothetical flight's new gate arrival time of 08:26 AM is converted into a cornerpost arrival time of 07:57 AM.

As shown in step 613, the cornerpost time may be displayed to a system operator or sent automatically to the pilot. If approved by the system operator, these modifications to the trajectories are communicated to the appropriate asset managers. In step 614, the present invention seeks a more optimum trajectory of all of the airline's other assets and, as seen in step 615, each asset is notified of their individual trajectory changes and the final, optimized gate arrival times.

Because many of the parameters and factors that go into this decision making process can change rapidly, a final step 616 is necessary to continuously monitor these input data sources to ensure that deviations to these parameters that alters the “goodness” of the current solution set beyond specified tolerance levels will result in the re-optimization of the airline's asset trajectories.

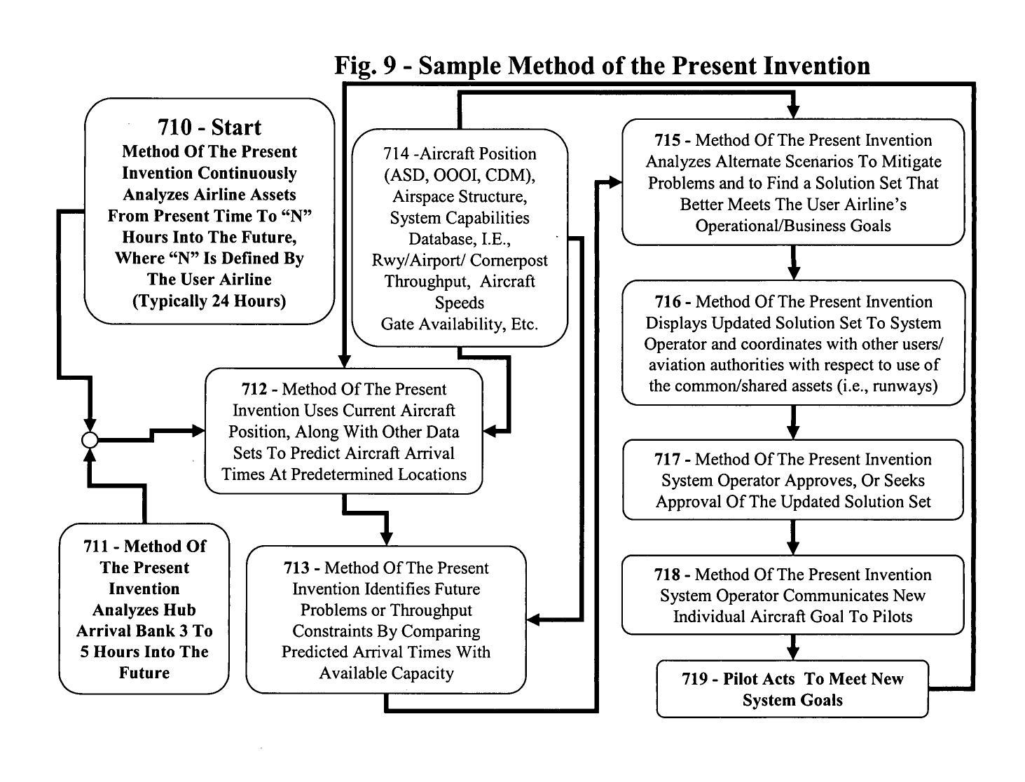

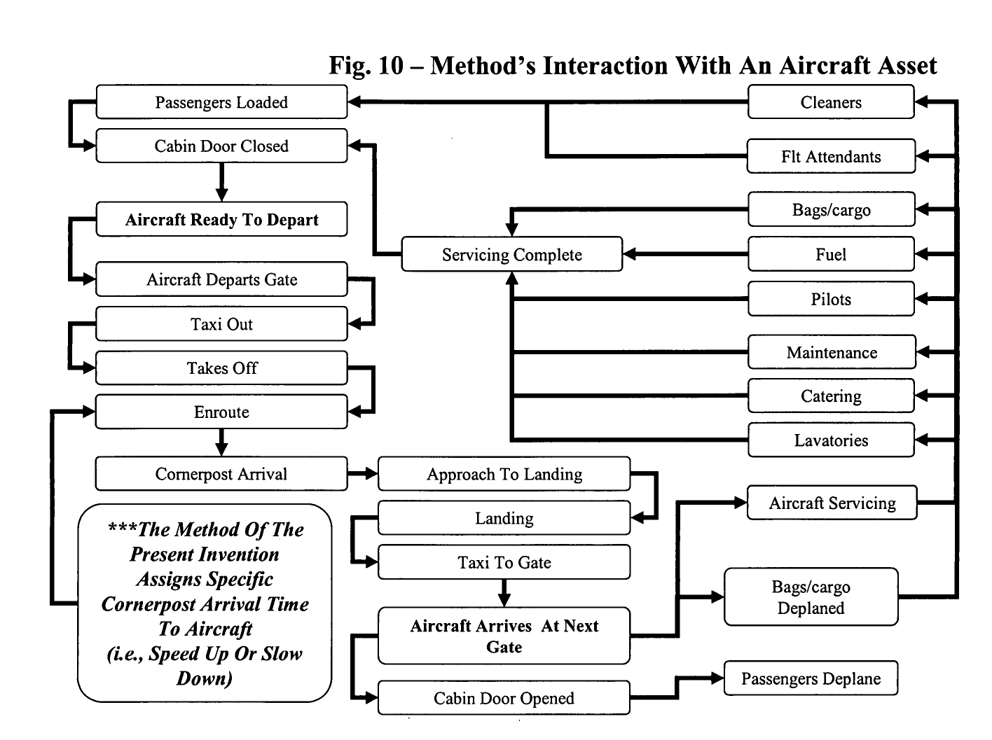

FIG. 9 further illustrates another depiction of one embodiment of the present invention as it seeks to first optimize the flow of an airline's aircraft. How an airline's other assets (both vehicular & labor assets) must interact with an aircraft whose performance is being attempted to optimize is shown in FIG. 10. Before passengers can be loaded, the cleaners must complete their tasks and the flight attendants must be on the aircraft. Once passengers are loaded the cabin door is closed. The aircraft departs the gate by taxing to the take off runway. Prior to or after taking off and while enroute to a cornerpost arrival, the method of the present invention results in assigning a specific cornerpost arrival time to each aircraft. The asset operator (pilot) then has options concerning the best methods for either speeding-up or slowing-down to meet the assigned arrival time. The aircraft lands and then taxies to the gate. The aircraft, upon arrival at the gate opens the door, bags and cargo are deplaned, and passengers deplane. At this point the aircraft is serviced. And the process begins anew.

FIG. 11 illustrates the various types of data (and how that data moves within the present invention) that is used in this decision making process within one embodiment of the present invention. These include: air traffic control objectives, generalized surveillance, aircraft kinematics, communication and messages, airspace structure, airspace and runway availability, labor resources, aircraft characteristics, arrival and departure times, weather, gate availability, maintenance, other assets—i.e. lavatories and galley trucks characteristics, and airline business and operational goals.

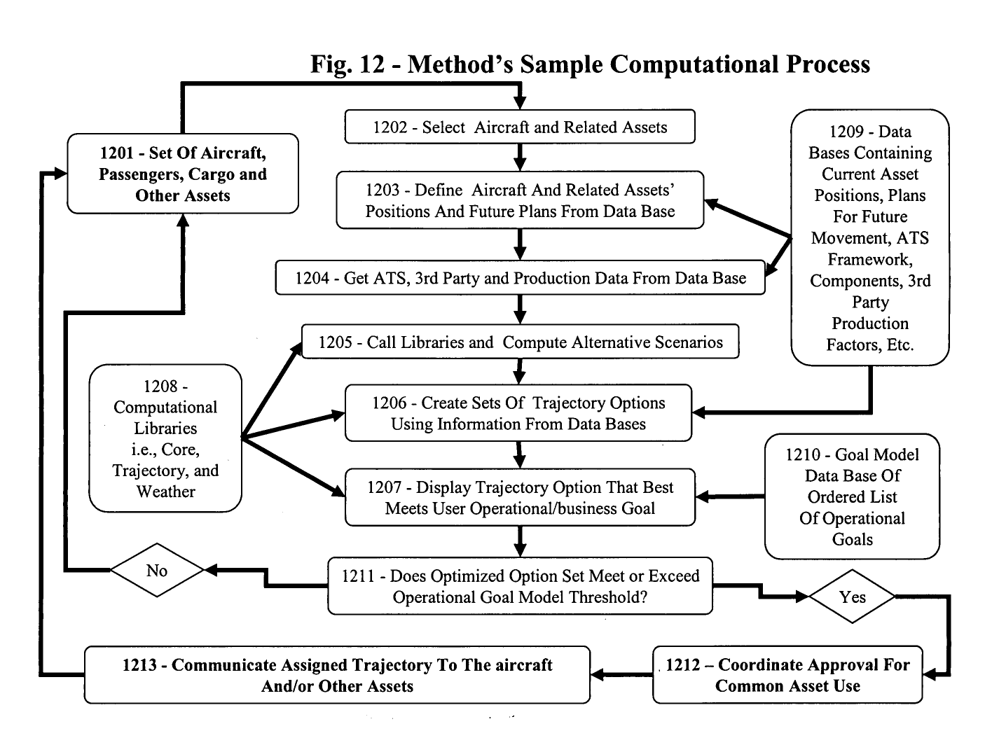

FIG. 12 illustrates some of the various computational processes that are associated with one method of the present invention. Starting with a set of aircraft, passengers, freight, and related assets, an aircraft and related assets are selected. Then the aircraft and its related assets' positions and future plans are identified with input from databases containing current asset positions, plans for future movement, ATS framework, components, third party data, production factors, etc.

An assortment of standard software programs may be used to compute an aircraft's alternative trajectories or flight scenarios. Such alternatives for all of an airline's aircraft approaching a particular hub are then combined to yield the trajectory option sets for an airline. An airline's prioritized and ordered list of operational goals are then used to evaluate the various option sets so as to identify a set that better meets the airline's business and operational goals. As a result of this process, an airline's aircraft trajectories are altered, assuming that the optimized option set exceeds a specified operational goal threshold. If it does not the process begins anew.

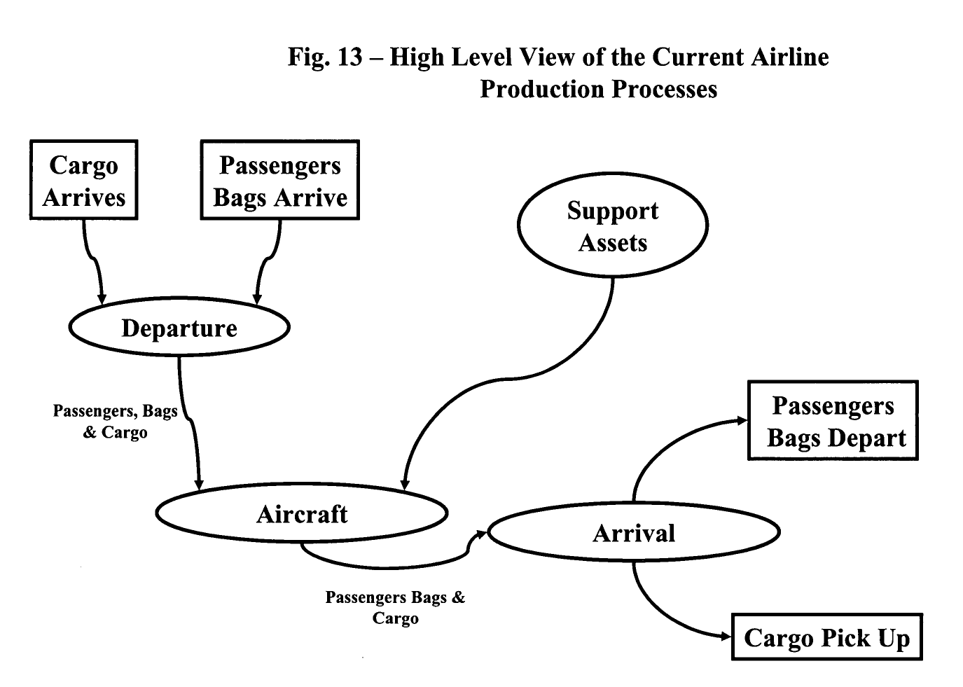

FIG. 13 displays the various high-level tasks that are currently being managed, mostly independently, in the operation of a typical airline; these include the tasks associated with on-ground support and the arrival/departure of the airline's aircraft.

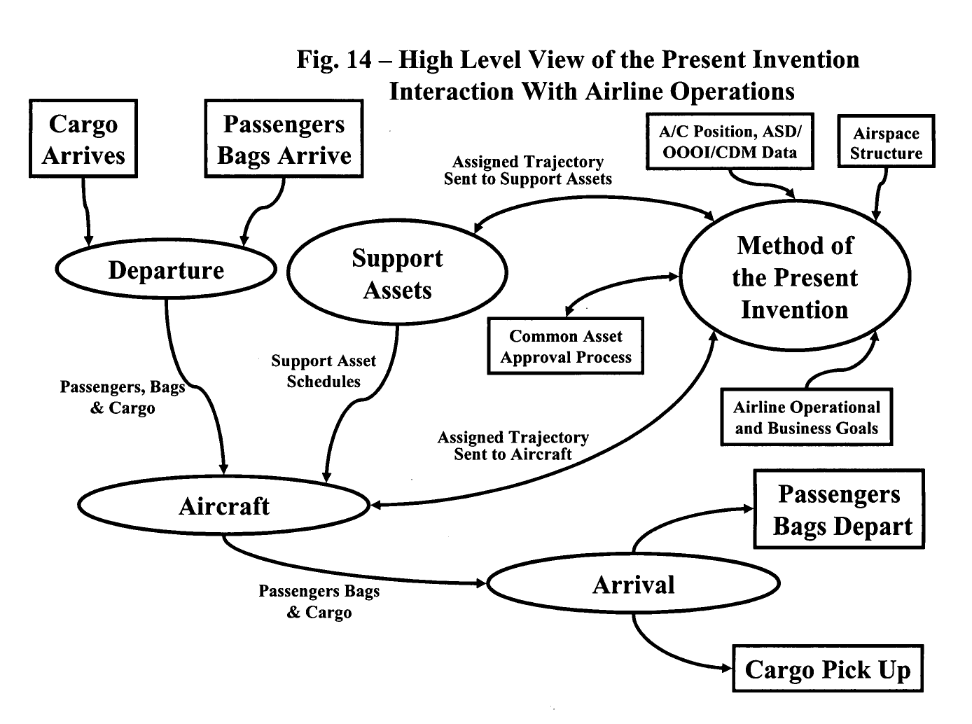

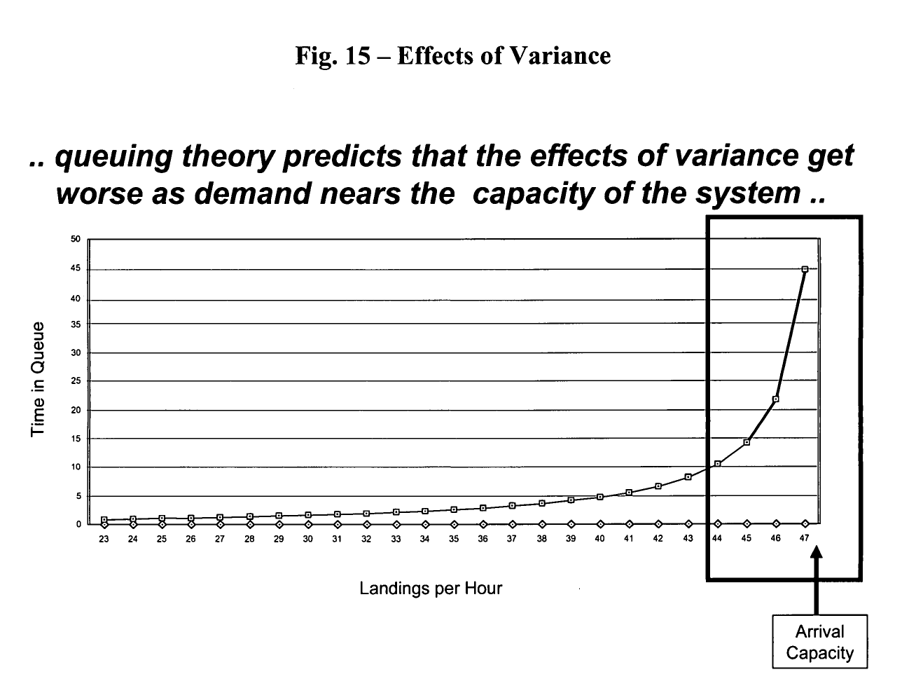

FIG. 14 illustrates the present invention's interaction points with the standard airline operational steps as shown in FIG. 13. This process is seen to receive input from the ASD/OOOI/CDM data, airspace structure data, and the user airline's business and operational goals, and to communicate trajectory modifications to the airline's aircraft and its ground support assets.

A key advantage of the process of the above described embodiment of the present invention is that it takes into consideration a more complete picture of the various factors that can effect the optimal operation of an airline, including a user airline's controlled assets, as well as other third party/competitor's aircraft and assets which are usually vying for access to an airport's common assets. Use of the process of the present invention is fundamentally different than the piecewise decision processes that are currently being used in the airline industry, which may often sub-optimize a particular objective, such as the passenger boarding process, without regard to the other involved processes (e.g., the cargo loading process).

Thus, this overall optimization phase and the present invention's ability to direct the outcome of future events is seen to be at the core of the process of the present invention. The output of the present invention directs and monitors the trajectory modification of an airline's aircraft and related assets.

It should be noted that it is a unique aspect of the present invention that, instead of merely processing currently available data to predict future events (e.g., gate arrival times) as is done by the current art, the method of the present invention actually works to modify the trajectories of the user airline's interdependent assets (speed up or slow down) to tilt the future outcome of certain events (hub arrival sequence) to the benefit of the user airline. Additionally, the present invention does this from a total system perspective, coordinating the directed actions to minimize system interference. In other words, the present invention works to coordinate and direct the outcome of a group of interdependent actions, rather than simply predicting what that outcome might be.

Note should also be taken of the importance of the accuracy of the input data on the validity and reliability of the predicted trajectories or outcomes for the transport of passengers, luggage and cargo, and, ultimately, the management effectiveness of the present invention. Therefore, in one embodiment of the present invention, after the trajectories are built, the present invention has an element that assesses the accuracy of the trajectories. This trajectory accuracy assessment is based on an internal predetermined set of rules that assigns a Figure of Merit (FOM) to each trajectory.

For example, if an aircraft is only minutes from landing, the accuracy of the estimated landing time is very high. There is simply too little time for any action that could alter the landing time significantly. Conversely, if the aircraft has filed its flight plan (intent), but has yet to depart Los Angeles for Atlanta, there are many actions or events that could decrease the accuracy of the predicted arrival time.

It is easily understood that the FOM for these predictions is a function of time. The earlier in time the prediction is made, the less accurate the prediction will be and thus the lower its FOM. The closer in time the aircraft is to landing, the higher the accuracy of the prediction, and therefore the higher its FOM. Effectively, the FOM represents the confidence the present invention has in the accuracy of the predicted landing times. Along with time, other factors in determining the FOM include the availability of wind/weather data, information from the pilot, etc.

Once the trajectories are built and their FOMs are determined high enough, the value of goal function is computed based on these predicted arrival times. Such a computation of the goal function often involves an algorithm that assigns a numerical value to each of its parameters based on the predicted arrival times. Often these parameters can be affected in contrasting ways by changing the predicted arrival times one way or another. For example, while it is an assumed goal to land an aircraft every minute, if the aircraft are not spaced properly, one solution is to speed up some of the aircraft, which requires more fuel to be used. Landing every minute is a plus, while burning extra fuel is a minus.

To provide a better understanding how this goal function process' optimization routine may be performed, consider the following mathematical expression of a typical scheduling problem in which a number of aircraft, 1 . . . . n, are expected to arrive to a given point at time values t₁ . . . tₙ. They need to be rescheduled so that:

The time difference between two arrivals is not less than some minimum, Δ;

The arrival/departure times are modified as little as possible;

Some aircraft may be declared less “modifiable” than others.

We use dᵢ to denote the change (negative or positive) our rescheduling brings to tᵢ. We may define a goal function that measures how “good” (or rather “bad”) our changes are for the whole aircraft pool as
G₁=Σᵢ|dᵢ/rᵢ|^{K}

where rᵢ are application-defined coefficients, putting the “price” at changing each tᵢ (if we want to consider rescheduling the i-th aircraft “expensive”, we assign it a small rᵢ, based, say, on safety, airport capacity, arrival/departure demand and other factors), thus effectively limiting its range of adjustment. The sum runs here through all values of i, and the exponent, K, can be tweaked to an agreeable value, somewhere between 1 and 3 (with 2 being a good choice to start experimenting with). The goal of the present invention is to minimize G₁ as is shown below.

Next, we define the “price” for aircraft being spaced too close to each other. For the reasons, which are obvious further on, we would like to avoid a non-continuous step function, changing its value at Δ. A fair continuous approximation may be, for example,
G₂=ΣᵢⱼP((Δ−|dᵢⱼ|)/h)

where the sum runs over all combinations of i and j, h is some scale factor (defining the slope of the barrier around Δ), and P is the integral function of the Normal (Gaussian) distribution. dᵢⱼ stands here for the difference in time of arrival/departure between both aircraft, i.e., (tᵢ+dᵢ)−(tⱼ+dⱼ).

Thus, each term is 0 for |dᵢⱼ|>>Δ+h and 1 for |dᵢⱼ|<<Δ−h, with a continuous transition in-between (the steepness of this transition is defined by the value of h). As a matter of fact, the choice of P as the Normal distribution function is not a necessity; any function reaching (or approaching) 0 for arguments <<−1 and approaching 1 for arguments >>+1 would do; our choice here stems just from the familiarity.

A goal function, defining how “bad” our rescheduling (i.e., the choice of d) is, may be expressed as the sum of G₁ and G₂, being a function of d₁ . . . dₙ:
G(d₁ . . . dₙ)=KΣᵢCᵢdᵢ²+ΣᵢⱼP((Δ−|dᵢⱼ|)/h)

with K being a coefficient defining the relative importance of both components. One may now use some general numerical technique to optimize this function, i.e., to find the set of values for which G reaches a minimum. The above goal function analysis is applicable to meet many, if not all, of the individual goals desired by an airline/aviation authority.

To illustrate this optimization process, it is instructive to consider the following goal function for n aircraft:
G(t₁, . . . tₙ)=G₁(t₁)+ . . . +Gₙ(tₙ)+G₀(t₁ . . . tₙ)

where each Gᵢ(tᵢ) shows the penalty imposed for the i-th aircraft arriving at time tᵢ, and G₀—the additional penalty for the combination of arrival times t₁, . . . tₙ. The latter may, for example, penalize when two aircraft take the same arrival slot.

In this simplified example we may define
Gᵢ(t)=a×(t−t_{S})²+b×(t−t_{E})²
so as to penalize an aircraft for deviating from its scheduled time, t_{S}, on one hand, and from its estimated (assuming currents speed) arrival time, t_{E}, on the other.

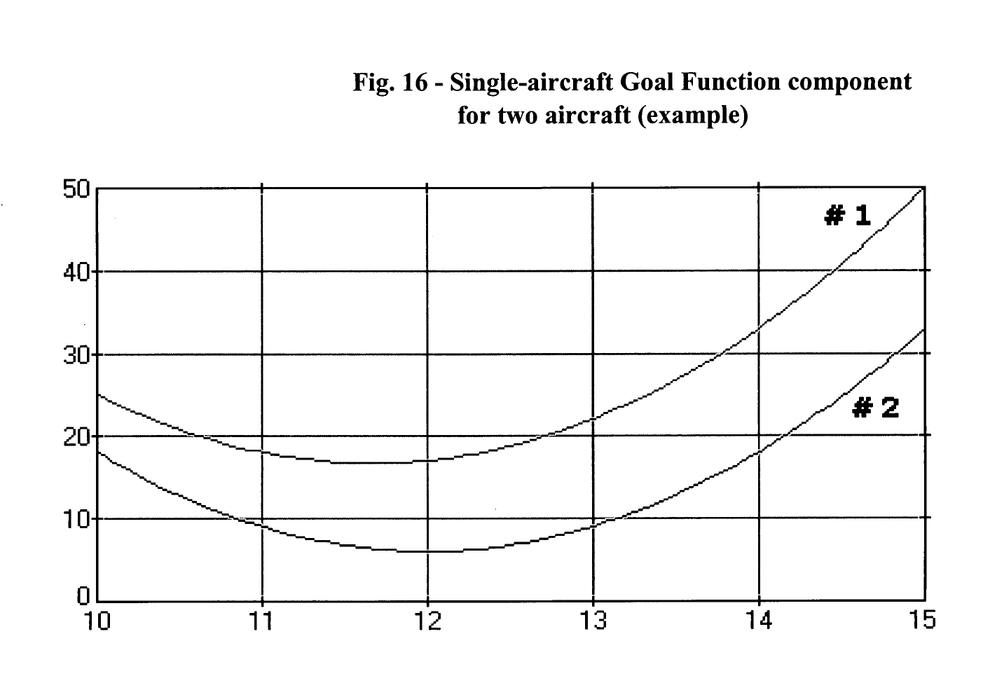

Let us assume that for the #1 aircraft tₛ=10, tₑ=15, a=2 and b=1. Then its goal function component computed according to the equation above, and as shown in FIG. 16, will be a square parabola with a minimum at t close to 12 (time can be expressed in any units, let us assume minutes). Thus, this is the “best” arrival time for that aircraft as described by its goal function and disregarding any other aircraft in the system.

With the same a and b, but with t_{S}=11 and t_{E}=14, the #2 aircraft's goal function component looks quite similar: the comparison is shown in FIG. 16.

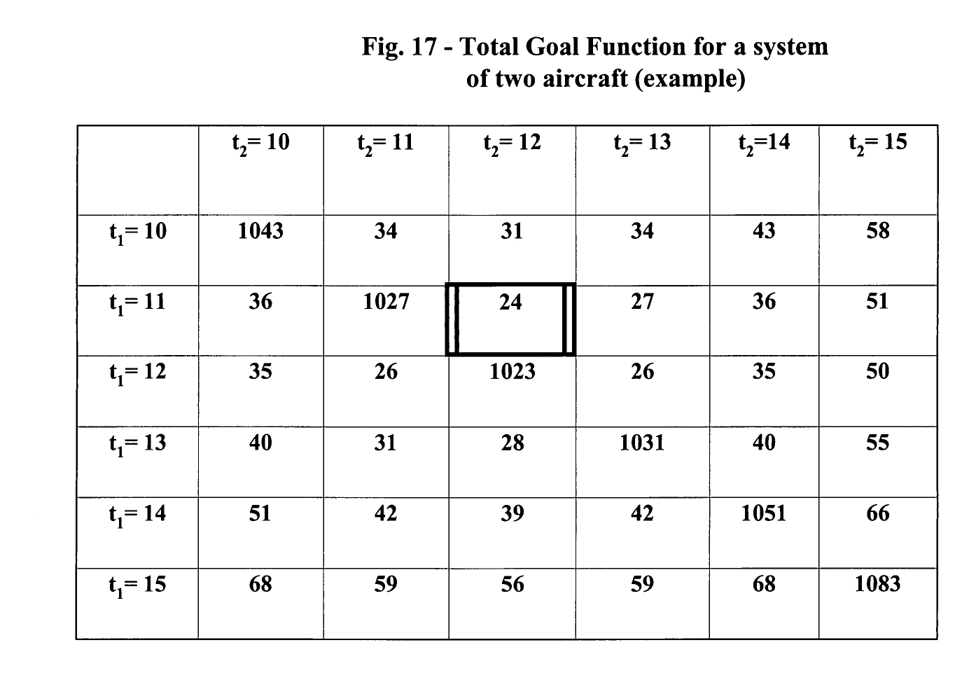

Now let us assume that the combination component, is set to 1000 if the absolute value (t₁−t₂)<1 (both aircraft occupy the same slot), and to zero otherwise. FIG. 17 shows the goal function values for these two aircraft.

The minimum (best value) of the goal function is found at t₁=11 and t₂=12, which is consistent with the common sense: both aircraft are competing for the t₂=12 minute slot, but for the #1 aircraft, the t₁=11 minute slot is almost as good. One's common sense would, however, be expected to fail if the number of involved aircraft exceeds three or five, while this optimization routine for such a defined goal function will always seek to find a better goal function value.

Finally, to better illustrate the differences between the present invention and the prior means used for managing an airline, consider the following examples:

### EXAMPLE 1

Although there are many ways to implement the present invention, after the benefits of the present invention are better understood, one of the preferred embodiments may include a stepped optimization process. In such a stepped optimization/management process of the present invention, an operator may implement the present invention using the following processes in the order below:
1. Aircraft location and long prediction process (U.S. Pat. No. 6,873,903).
2. Non aircraft asset (gates, crews, cleaners, maintenance, etc.) usage, location and prediction.
3. Aircraft flow optimization to better meet the operational/business needs of the airline operator (U.S. Pat. No. 6,463,383).
4. Aircraft gate optimization to assure that more aircraft have a better gate and that it is available when the aircraft arrives (see U.S. Patent Publication 2004/0071076A1).
5. Optimize the remaining process (cleaners, fuelers, crews, maintenance, etc.) to the proper gate and aircraft.

As described above, the first step in this embodiment of the present invention is to predict the future position of the controlled and non controlled aircraft. Therefore, on the evening of day 1, the present invention receives the data that the crew into MSP will arrive late.

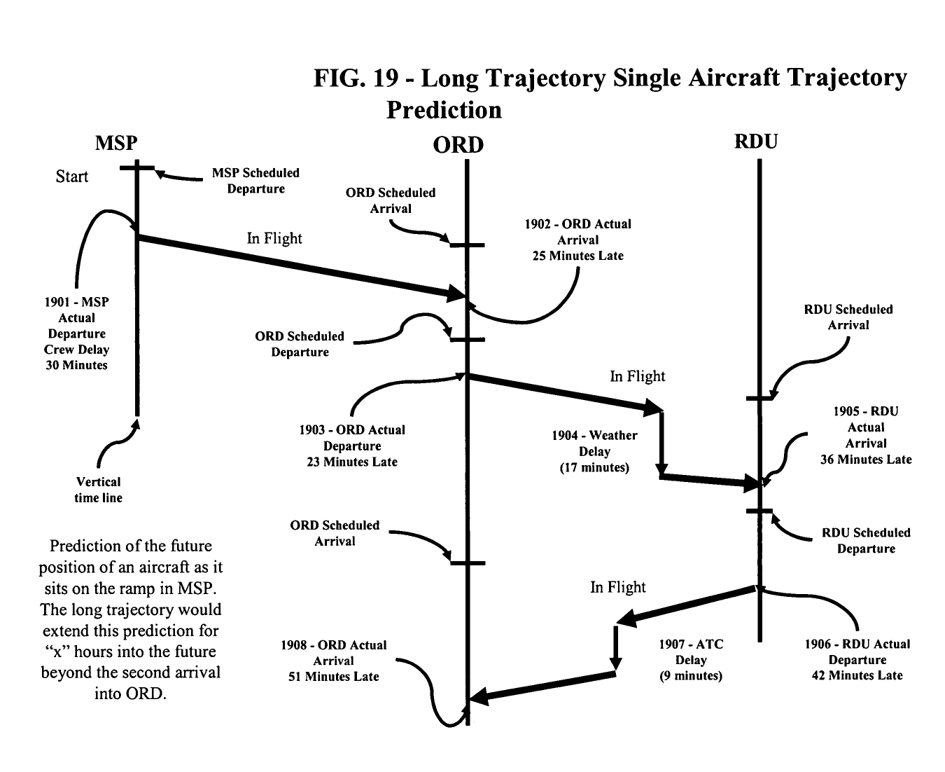

Then, using the single aircraft long prediction process for aircraft 3113 (see FIG. 19), it calculates the necessary crew rest requirement, predicts the late MSP departure (1901—30 minutes late) and ORD arrival (1902—25 minutes late), the late ORD departure (1903—23 minutes late), the RDU arrival (1905—36 minutes late), the late RDU departure (1906—42 minutes late) and finally, the late arrival into ORD (1908—51 minutes late).

At each step in this process, the present invention factors in other known data that could affect the aircraft's trajectory, for example, weather (1904—17 minute delay), ATC actions (1907—9 minute delay), the predicted enroute flight time, the predicted taxi time between the landing runway and the arrival gate, arrival gate availability, as well as the ground assets necessary to meet, offload, service and upload the aircraft throughout the series of flights.

Using the present invention, once it knows that the departure of aircraft 3113 will be late from MSP, and given the very tight schedule, the remainder of the day, the present invention would seek alternative scenarios, where the flight is closer and closer to on time as the day goes on. For example, it could seek to change the crew in MSP to a crew which has the required rest for the on time departure the next morning, but in this example, there are no crews available.

Given the lack of an alternate crew, the present invention could next seek to shorten the airborne segments of the three flights prior to the second ORD arrival. It is determined that, by burning more fuel, the MSP to ORD flight can be flown faster with an earlier arrival fix time 7 minutes prior to the predicted arrival time, the ORD to RDU segment 9 minutes faster and the RDU to ORD segment 12 minutes faster. The present invention, also knowing that the late flights will cause misconnections for its passengers, at a cost of thousands of dollars, compares this to the cost of burning the additional fuel.

Since the extra fuel cost is only 30% of the cost generated by the late passengers, the scenario which speeds up the flights is chosen. To accomplish this, the additional fuel must be loaded on each of the three flights, therefore, the present invention would send the target departure and arrival times for the three flights to the airline's flight planning system, where the increased speed is planned for and the necessary additional fuel calculated.

Next, the present invention would seek information about the trajectory of the non aircraft assets, which, in this case, are not a problem, since it is determined that all of the necessary non aircraft assets are available at ORD, RDU and ORD again to meet and service the aircraft at the updated projected arrival times.

Finally, the gate optimization process would seek to determine if parking gates are available for aircraft 3113, as well as all other aircraft predicted to arrive near the time aircraft 3113 arrives. Next the gate optimization process, using the information as to which runway aircraft 3113 will land into ORD from MSP, seeks to make the closest gate to the predicted landing runway available for aircraft 3113, so as to minimize the ground taxi time. Again, the gate process has enough gates available to service aircraft 3113.

This process would continue in the background, through the night and into the morning of day 2 until the Figure of Merit is above the defined threshold necessary for the present invention to act. For example, at approximately four hours prior to landing into ORD (2 hours prior to departing MSP) the first time, the gate optimization process assigns aircraft 3113 to gate 35, a gate close to the predicted arrival runway, thus minimizing taxi time. Next, at about 1.5 hours prior to departure, as the final flight plan is being generated for the MSP to ORD flight, because of a change in the winds, the first flight can now fly faster than originally predicted, arriving 2 minutes earlier than previously planned. The updated arrival time would then be sent to the pilot, the gate assignment process and all other interested personnel and systems.

Once airborne, it is determined that the aircraft took off two minutes later than originally predicted. Given that the aircraft was already planned at maximum speed, this loss of two minutes cannot be recaptured. Therefore, using the more accurate, actual takeoff time, an updated cornerpost arrival time for aircraft 3113 is generated (as well as for any other ORD arrival aircraft affected) and sent to the aircraft. Then the updated gate arrival time is recalculated, gate 35 reconfirmed and non aircraft assets predictions updated.

Finally, the non aircraft assets are optimized such that all of the non aircraft assets necessary to meet, offload, service and then upload aircraft 3113 for the ORD to RDU flight are all in place when aircraft 3113 arrives at the gate. Once optimized, the updated gate arrival time for aircraft 3113 is communicated to the interested personnel and systems so all of the necessary gate functions are at the right place at the right time when aircraft 3113 arrives.

Then, aircraft 3113 arrives and is offloaded, serviced and uploaded.

Next, aircraft 3113 takes off for the ORD to RDU flight 7 minutes earlier than predicted. Again, using the more accurate, actual takeoff time, an updated, and now 7 minute earlier RDU cornerpost arrival time for aircraft 3113 is generated and sent to the aircraft. Then the updated gate arrival time is recalculated, the gate and non aircraft assets predictions updated and sent to the interested personnel and systems.

And again, the non aircraft assets are optimized such that all of the non aircraft assets necessary to meet, offload, service and then upload aircraft 3113 for the RDU back to ORD flight are all in place when aircraft 3113 arrives at the gate.

Additionally, enroute to RDU, as more accurate information becomes available, the present invention determines that the arrival flow into ORD during the time aircraft 3113 is predicted to arrive is higher then available airport capacity and that aircraft 3113 is predicted to end up number 7 in the arrival queue, requiring an additional 12 minute arrival delay.

To mitigate the ORD arrival delay, the present invention would try to increase the speed of aircraft 3113 on the remainder of the ORD-RDU leg and the entire RDU-ORD leg. But as stated above, aircraft 3113 is already at maximum speed. Therefore, another option is to minimize the RDU ground time. To do this, the present invention would send the pilot and RDU ground staff a departure time 4 minutes earlier than predicted. It is determined that with the use of extra personnel, the ground time can be reduced by the required 4 minutes.

In addition to moving aircraft 3113 forward in time, it also needs to change the arrival sequence of the controlled aircraft arriving into ORD in the queue ahead of aircraft 3113, such that aircraft 3113 is number 4 in the queue.

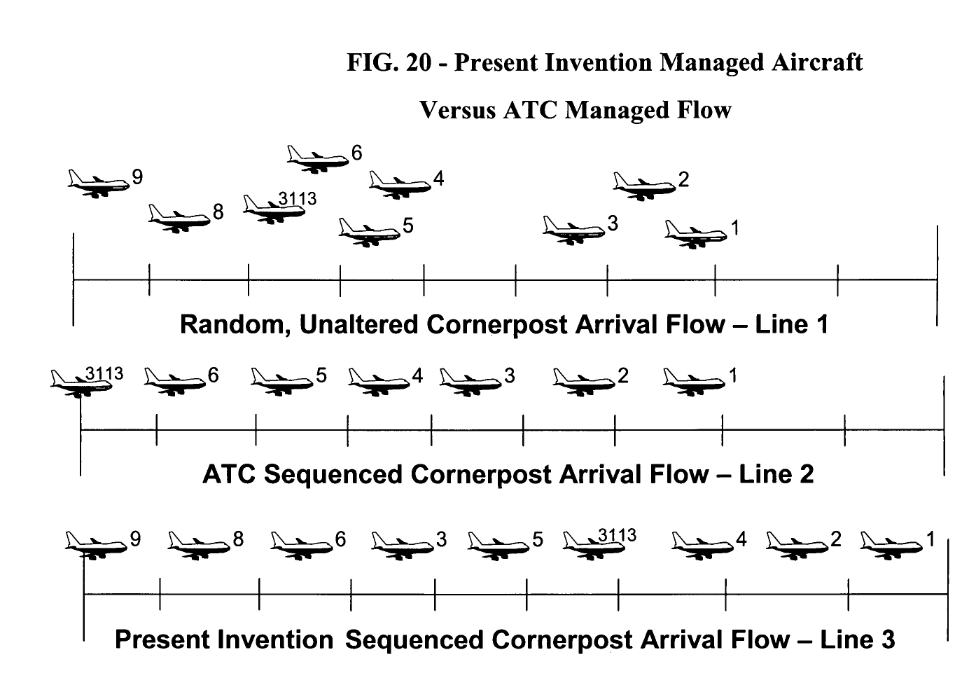

Unfortunately, as the present invention works through the alternate scenarios, it calculates that if two of the controlled aircraft ahead of aircraft 3113 (FIG. 20, #2 and #4) are slowed, they would then be late and if a third aircraft (FIG. 20, #1) is moved behind aircraft 3113, it would make the aircraft behind aircraft 3113 late. The present invention then chooses to speed up the #1, #2, and #4 and slow down #3, #5 and #6, all of which in an unmanaged flow would be ahead of aircraft #3113. This allows the entire queue to move forward (see line 3, FIG. 20). This is a unique aspect of the present invention, sliding the first few aircraft in the arrival queue forward from an overcapacity environment to an under capacity environment.

The present invention not only allows the entire arrival queue to slide forward, thus mitigating delays in current art as managed by the ATC controller, it also allows sequencing of the arrival queue so as to better meet the operational/business requirements of the airline.

As described herein, the embodiment of the present invention is a continuous process, wherein the present invention seeks an overall better solution for each flight, each gate and each non aircraft asset, day after day, hour after hour, so as to better meet the business/operational needs of the user airline. It does this in one preferred embodiment of the present invention by optimizing the aircraft flow first, and then optimizing the gates and other non aircraft assets to the aircraft flow as required (see FIG. 14). In other words, the present invention looks ahead to predict asset positions and potential problems, optimizes the assets by seeking alternative scenarios to mitigate these problems, and then communicates the better alternative scenario to the appropriate personnel for implementation.

### EXAMPLE 2

A pilot typically decides what speed to fly and how much fuel to use based on broad airline policies using a very limited view of the pertinent data. For example, an aircraft from Boston is predicted to arrive late into San Francisco, thus misconnecting five passengers for their flight to Hong Kong. Suppose the pilot has the ability to increase speed to allow the arrival in San Francisco early enough for these connecting passengers to board the Hong Kong flight. To do this the pilot would have to use an additional $1,000 of fuel.

Conversely, if the passengers misconnect to the Hong Kong flight, the airline engenders an additional cost of $1,200. Obviously the pilot should use the extra fuel to arrive in time to assure that the five passengers may board the Hong Kong flight, thus saving the airline $200.

This example represents a fairly simple decision making process. Unfortunately, even this simple decision is not often made because the information needed is often not made available to the right people, or if the data is available, the people making the decisions do not have the ability to process the data.

Often, little thought is given to other real time factors that could affect the outcome of the arrival time (i.e., the arrival flow demand versus capacity at San Francisco). Suppose that the message was sent to the pilot concerning the Hong Kong connections, but the airline ignored the fact that at the time the aircraft approached San Francisco, numerous other aircraft, including the airline's competitors, were also arriving in San Francisco, pushing arrival demand above arrival capacity. If more aircraft arrive at the airport than the airport can safely land, the system becomes congested. Congestion causes delays and backups.

In this example, the initial analysis considered only a single factor, while other factors precluded the passengers' making their connections. The airline spent $1,000 for extra fuel, while still misconnecting the passengers, thus costing the airline a total of $2,200.

The process of the present invention could provide a predicted scenario for at least “n” hours into the future, as the Boston to San Francisco flight is ready to depart Boston (see U.S. Pat. No. 6,873,903). It would identify the constraint points and analyze alternate asset trajectory scenarios to mitigate these constraints to assure that there was an available landing slot, an available gate, and services required for the connecting passengers to make the Hong Kong flight.

The process can also address much more complex scenarios. For example, assume that the pilot of the Boston to San Francisco flight was directed to speed up to connect the Hong Kong passengers without regard of San Francisco's ability to handle the earlier arrival of the Boston flight. Arbitrarily adding increased demand for San Francisco's runways (the common asset) at a certain point in time has the consequence of moving back other aircraft also flying into San Francisco. Also consider that another aircraft, owned by the same airline, flying from Dallas to San Francisco was subsequently delayed by the early arrival of the Boston flight. The Dallas flight had twenty passengers connecting to Australia with a minimum connect time. Now because of actions of the crew on the Boston flight without regard to the system view, the passengers on the Dallas flight missed their connection to Australia. The bottom line—the airline loses.

On the other hand, the process of the present invention's tactical management system not only evaluates the Boston to San Francisco flight as described above, but it also evaluates the Dallas flight as well. By managing the arrival flow of the controlled assets and tracking the uncontrolled assets, it seeks a trajectory set that allows both flights to have access to the available resources as best as physically possible.

### EXAMPLE 3

As pilots, mechanics and customer service agents take independent actions to enhance their controlled assets, they often create interference and additional cost for their airline. A maintenance foreman may direct mechanics to learn the process of fixing an aircraft braking system on a late aircraft rather than assign a mechanic who has fixed that particular braking system numerous times in the past.

To avoid the cost of having system specialists standing by to fix a problem as rapidly as possible, an aircraft may be delayed an extra forty-five minutes while the less experienced mechanic assures that the job is done safely. Unbeknownst to the foreman, his action caused cancellations of two down-line flights costing the airline thousands of dollars. His action was taken to avoid additional cost of a few hundred dollars, but unfortunately ends up costing the airlines many thousands of dollars.

### EXAMPLE 4

Flight 35 is scheduled to arrive at the gate in Chicago at 0830 and depart at 0905, with a minimum ground time. Unfortunately, Flight 35 is delayed into Chicago and will not arrive until 0850, twenty minutes late. The process of the present invention allows an airline to evaluate the trajectories of all Chicago bound aircraft (as well as the trajectories of the airline's other assets, passengers and cargo) for possible modifications. For example, it can identify that, because of fuel concerns, Flight 35 cannot speed up to arrive any earlier. It can also calculate that Flight 50 (schedule to arrive at the gate in Chicago at 0845 and depart at 0930) can increase speed and arrive at 0835 (ten minutes early). Next, it determines that the future trajectories of these two aircraft are such that the two aircraft can be swapped, so that the inbound Flight 50 aircraft is used as the outbound Flight 35 and the inbound Flight 35 aircraft is used as outbound flight 50. To assure that both flights depart on time, the process can calculate all required times based on the best tactical (latest) information. The trajectories of the ground personnel and assets can also be evaluated to assure that they are able to meet the needs of both aircraft (as well as all of the other aircraft). The process of the present invention can send a message to inbound Flight 50 to arrive at the arrival cornerpost (or ATC merge point) at 0810 so as to arrive at the gate at 0835. Next a message can be sent to inbound Flight 35 to arrive at the arrival cornerpost at 0830 so as to arrive at 0855. This allows inbound Flight 35 to slow down to conserve fuel, while still assuring enough gate time to meet all its needs to depart as Flight 50 on time at 0930. Additionally, the process makes it able for the ground support personnel to be notified of the change as well as alerting them that, for example, the passenger loads on inbound Flights 50 and outbound Flight 35 are low enough to assure Flight 35 can depart on time at 0910, shaving five minutes off the minimum gate time because of the real time demands of the two flights. Notification of the change and actual arrival times limit the chances of any delays in ground servicing.

### EXAMPLE 5

Flight 72 from LaGuardia to Washington National is canceled. The next flight, Flight 75 is scheduled for an aircraft that is too small to carry the combined loads of the two flights. The process of the present invention, through evaluation of the current and future trajectories of all of the airline's assets (especially the aircraft), determines that a larger aircraft can be substituted for the smaller aircraft. To do this, numerous factors must be evaluated, including: the future trajectories of both aircraft, the capacities (seats and cargo space) available, the trajectories of the scheduled passengers and cargo, maintenance requirements of both aircraft and when they can be swapped back to complete their scheduled activities. While this function is accomplished in the current art, it is done manually, or late in the process.

### EXAMPLE 6

Numerous airline delays are caused by the unavailability of an arrival gate. Current airline management techniques typically assign gates on a strategic basis and only make modifications after a problem develops. The process of the present invention, through its ability to evaluate and mesh the current and future trajectories of the airline's assets, can assign arrival gates tactically. By assigning the arrival gates based on actual gate needs (at one to n hours prior to arrival), more aircraft can be accommodated (see U.S. Patent Publication 2004/0071076A1).

### EXAMPLE 7

Given the increased predictability of the aircraft arrival time, the process of the present invention can sequence the ground support assets to better meet the needs and or wants of the aircraft. For example, it is customary to load the catering truck with more than one flight's food and beverage carts. By more accurately knowing the gate arrival time of the aircraft one to two hours prior to arrival, the catering truck can be loaded with the correct catering carts in the correct order. This reduces the time necessary to offload the catering carts at each aircraft, better assures that the catering is delivered to the correct aircraft at the correct time so as to not delay the next departure.

### EXAMPLE 8

Hub operations typically require a large number of actions to be accomplished by an airline in a very short period of time. One such group of events is hub landings and takeoffs. Typically in tightly grouped hub operation, the departures of the user airline from the last hub operation compete for runway assets (a common asset) with the arrivals of the same user airline for the next hub operation. It is one embodiment of the present invention to coordinate landing times with takeoff times for the controlled aircraft, thus allowing the user airline to minimize delays for access to the available runway for both takeoffs and landings or allow delays to accrue to the aircraft that can best tolerate delays.

One example of the present invention might be to speed up some or all controlled aircraft arrivals (move up the production of arrivals which would increase fuel usage) to reduce runway arrival demand during the period when the runway is needed for departures. Another example might be moving up some or all of the departures, although it is recognized that moving any departure forward in time is more difficult given the fixed departure time associated with each flight. In either case, the arrival or departure aircraft that have their trajectories altered, forward or later in time, would be coordinated from a system perspective. For example, if a set of departure aircraft needed to be moved forward, the present invention might sequence the departure aircraft based on those that are already late for some other reason, or those that have little to no ability to speed up enroute.

### EXAMPLE 9

When aircraft in a hub bank depart, they often depart at or close to the same time. In the current art, without tactical departure information considered in the gate assignment process, these aircraft routinely block each other as they push back from the gate. For example, aircraft #1 pushes back from gate A at 1230. Aircraft #2, which is to the right of #1 at gate B, pushes back at 1232, # 3, to the right of #2, at 1234 and #4, to the right of #3, at 1236. Because of the ramp configuration, all aircraft must turn to their right to taxi to the runway and with the gates so close together; aircraft must wait until the aircraft to its right moves.

This means that even though aircraft #1 is ready to taxi soon after it pushes from gate A, it must wait for #2 to leave from gate B, which must wait for #3 to depart, which must wait for #4 to turn out. In other words, assuming that all aircraft require the same amount of time to push from the gate an prepare to taxi, Aircraft #1 must wait a minimum of 6 extra minutes to begin taxi, #2 must wait an extra 4 minutes and #3 an extra 2 minutes. And further decreasing the efficiency of the operation the first come, first serve process of the ATC system assigns the first takeoff to aircraft #4, the first aircraft in line and the first to taxi. This further delays aircraft #1, #2 and #3.

In the method of the present invention, the predicted departure times are used in the goal function process to determine a more efficient gate assignment solution.

In this example, assuming all other parameters are equal, one solution might be to reverse the gate assignments, such that aircraft #4 would be assigned gate A, aircraft #3 assigned gate B, etc. Then as the aircraft depart, aircraft #1, the first to depart, would be the on to the farthest right and immediately able to taxi after the push back process. In fact, there would be no taxi delay for any of the four aircraft.

Another solution would be to speed up or slow down aircraft inbound to the hub and assign the aircraft different gates. In this solution, the present invention would also seek to assign the secondary processes (cleaners, baggage personnel, food service personnel, etc.) to the right gate and the right aircraft so as to minimize gate time, as well as avoid congestion during the departure.

### EXAMPLE 10

One of the unique elements of the present invention is the concept of long or multi-segment trajectories. This involves the consideration of many factors and allows the present invention to predict and seek ways to mitigate potential problems in a future segment of a flight prior to or several flight segments before the future problematic segment.

To better understand this concept, it is instructive to first work backward to determine why an assumed problem occurred (e.g., a late RDU departure on a flight going to ORD). In this example, the aircraft that is to fly RDU to ORD departed ORD late on its way to RDU and was delayed enroute by weather. Looking farther back in time, the ORD late departure was caused by a late departure and arrival of the aircraft from MSP to ORD. And the late MSP departure was caused by the late arrival of the crew the previous evening which needed adequate crew rest for safety reasons.

Turning this around to a forward looking prediction process, see FIG. 19, once the present invention receives and analyzes the data of the late arrival of the crew into MSP, it then calculates the necessary crew rest requirement, predicts the late MSP departure (1901—30 minutes) and ORD arrival (1902—25 minutes), the late ORD departure (1903—23 minutes), the enroute weather delay (1904—17 minutes) and RDU arrival (1905—36 minutes) and finally the late RDU departure (1906—42 minutes). At each step in this process, the present invention would also factor in numerous other factors that could affect the aircraft's trajectory, ATC actions (1907—9 minutes from RDU to ORD which could be caused by the departure demand at the runways, possible local airborne departure constraints again based on departure loads, possible enroute constraints, the arrival demand at the destination airport), the time enroute requirement, the distance between the landing runway and the arrival gate, arrival gate availability and weather throughout the movement of the flight.

Using the long prediction process within the present invention, once an airline knows that the RDU departure is predicted to be late, it may act to mitigate this delay. For example, one of the alternate scenarios could include that the airline could change the crews in MSP to a crew, which has the required rest for the on time departure the next morning. Another possible scenario might be to speed up the aircraft for all flights during the day prior so that the aircraft is not required to be delayed out of MSP into ORD. The goal function would examine each of these possible scenarios and assign a value to the outcome. Of the possible scenarios examined, the goal function would then take the scenario with the goal function value that best meets the airline's business and operational goals.

### EXAMPLE 11

An aircraft is predicted to land at 12:15 (#1), no aircraft predicted to land at 12:16, 12:17, 12:18, or 12:19, and four aircraft (#2 through #5) are predicted to land at 12:20. To accomplish this landing sequence, air traffic control would slow down—flatten out—the arrival flow 15 to 20 minutes or more prior to landing, moving over capacity aircraft backwards in time. In this example of an airport, where the allowable landing rate is 60 aircraft per hour or one per minute using the standard air traffic controller first come, first serve landing sequence process, the following sequence would occur:
aircraft #1 would land at 12:15;
aircraft #2 would land at 12:20;
aircraft #3 would land at 12:21;
aircraft #4 would land at 12:22;
and, aircraft #5 would land at 12:23.

In the process, air traffic control would use delay vectors or speed reductions for aircraft #3 through #5, causing them to unnecessarily burn more fuel. Also, if aircraft #1, #2 and #3 are all 10 minutes early, while #4 was scheduled to land at 12:17 and #5 was scheduled to land at 12:18, the air traffic controllers actions, although necessary so late in the arrival flow, will assure that both aircraft will be 5 minutes late.

Applying the present invention, to the example above, all aircraft would be assigned an arrival fix time much earlier in the arrival flow (50 to 90 minutes prior to the arrival fix), and therefore a landing slot and be on time. Specifically, if aircraft #4 can speed up 3 minutes so that it lands at 12:17 and aircraft #5 is sped up to land at 12:18, both would now be on time. Further, if, prior to the actions by the air traffic controller, aircraft #1 is slowed down to land at 12:16, aircraft #2 is slowed to land at 12:22 and aircraft #3 is slowed to land at 12:23, these aircraft will save fuel.

The result: by moving the arrival aircraft only two to three minutes (i.e., accomplished 50 to 90 minutes prior to the arrival fix or 60 to 120 minutes prior to landing), the present invention reconfigures the aircraft arrival pattern so that air traffic control actions are no longer necessary and all aircraft arrive on time. The air traffic control managers will not be forced to use delaying vectors or speed reductions, thus eliminating the tremendous waste of fuel. Compare this to first example which resulted in delays and additional expenses. In other words, once the prediction of the aircraft arrival flow problem is made and the outcome is understood, an alternative scenario can possibly be found (i.e., the aircraft arrival flow can be optimized) and communicated to the pilots for implementation (speed up or slow down, as necessary).

Those skilled in the art of data processing understand that the present invention may be embodied in a software and hardware system that performs as depicted in FIG. 6a-6d flowcharts and diagrams found in FIGS. 9, 12 and 14.

Numerous technologies meet the individual data input requirements of the present invention. The specific technologies described herein (e.g., PASSUR, ASD, ACARS, etc.) are not meant to limit the scope of this patent, but are discussed to better describe, and help the reader to better understand the present invention. While it is envisioned that computer technologies represent the baseline application by most airlines, the application of the process of the present invention may be accomplished manually (albeit, much less efficiently). Additionally, in the future, newer technologies and more accurate data sources may provide better solutions to improve the individual steps in the process, thus improving the overall invention.

While it is recognized that the movement of aircraft represent the core airline process as described herein, the tactical management of all of the airline assets is important to determining the most profitable solution, for each given scenario. The description of the management of the aircraft asset herein is also not meant to limit the scope of the patent. For example, the present invention will just as easily simultaneously manage all of the airline's assets, i.e., passengers as work-in-process assets, food trucks, pilots, etc. All of these, and all of the other of the user airline's assets must be tactically managed from a system perspective to operate the airline system in the most profitable manner.

The foregoing description of the invention has been presented for purposes of illustration and description. Further, the description is not intended to limit the invention to the form disclosed herein. Consequently, variations and modifications commensurate with the above teachings, and combined with the skill or knowledge in the relevant art are within the scope of the present invention.

The preferred embodiments described herein are further intended to explain the best mode known of practicing the invention and to enable others skilled in the art to utilize the invention in various embodiments and with various modifications required by their particular applications or uses of the invention. It is intended that the appended claims be construed to include alternate embodiments to the extent permitted by the current art.

We claim:

1. A method for managing the operational assets of an airline for the transport of the passengers, luggage and cargo of said airline in such a manner as to allow the business and operational goals of said airline to be met to the highest degree possible, wherein said method based upon specified data pertaining to said airline assets, passengers, luggage, cargo and goals, said method comprising the steps of:
collecting and storing data on the status of said airline assets, passengers, luggage and cargo,
processing said specified data and said status data to predict the outcomes that will be achieved for the transport of said passengers, luggage and cargo,
processing said predicted outcomes to determine the degree to which said airline goals are expected to be met as a result of said predicted outcomes,
identifying for a future point in time how the most recent specified and status data would have to feasibly change so that if such changed data were to be applicable at said future point in time that its use to predict said outcomes would yield results for the transport of said passengers, luggage and cargo that give a higher degree of attainment of said airline goals than that achieved by using said initially predicted outcomes,
processing said feasible changes to identify the tasks that must be accomplished by said airline assets within the time period prior to said future point in time so as to make said identified changed data applicable at said future point in time,
developing instructions for said airline assets as to how they are to perform said tasks, and
communicating said instructions to said airline assets.

2. A method as recited in claim 1 further comprising the step of:
when a portion of said tasks require coordination chosen from the group consisting of coordination for regulatory control or non-regulatory coordination with others outside of said airline, obtaining said coordination approval for said airline assets to perform said tasks.

3. A method as recited in claim 1 further comprising the step of:
monitoring the progress of said assets towards accomplishing said tasks so as to identify when a situation arises that will prevent one or more of said tasks from being accomplished in a timely manner so as to prevent the achievement of the outcomes necessary for said higher degree of attainment of said airline goals than that achieved by said initially predicted outcomes, and
when said situation is identified, beginning again the steps of identifying new feasible changes, processing said new feasible changes to identify new tasks that must be accomplished by said airline assets, developing new instructions for performing said new tasks, and communicating said new instructions.

4. A method as recited in claim 2 further comprising the step of:
assessing the accuracy of said collected status data and, for the purposes of processing said data, applying a weighting factor to said data that reflects said accuracy assessment.

5. A method as recited in claim 1:
wherein said airline asset management takes place within the constraints of an aviation system having defined resources, and wherein said method based upon specified data pertaining to said aviation system resources,
said method further comprising the steps of:
including in said status data collecting and storing step the collection and storage of data on the status of said aviation system resources, and
including in said data processing step the processing of said specified data and said status data for said aviation system resources.

6. A method as recited in claim 4:
wherein said airline asset management takes place within the constraints of an aviation system having defined resources, and wherein said method based upon specified data pertaining to said aviation system resources,
said method further comprising the steps of:
including in said status data collecting and storing step the collection and storage of data on the status of said aviation system resources, and
including in said data processing step the processing of said specified data and said status data for said aviation system resources.

7. A method as recited in claim 5:
wherein said airline asset management takes place within the constraints of sharing said system resources with the assets of another airline, and wherein said method based upon specified data pertaining to said assets of other airline,
said method further comprising the steps of:
including in said status data collecting and storing step the collection and storage of data on the status of said assets of said other airline, and
including in said data processing step the processing of said specified data and said status data for said assets of said other airline.

8. A method as recited in claim 6:
wherein said airline asset management takes place within the constraints of sharing said system resources with the assets of another airline, and wherein said method based upon specified data pertaining to said assets of other airline,
said method further comprising the steps of:
including in said status data collecting and storing step the collection and storage of data on the status of said assets of said other airline, and
including in said data processing step the processing of said specified data and said status data for said assets of said other airline.

9. A method as recited in claim 5, wherein:
said specified data is chosen from the group consisting of the temporally varying positions and trajectories of the aircraft and other vehicular assets and the mobile labor assets of said airline, the temporally varying weather conditions surrounding said aircraft and system resources, the flight handling characteristics of said aircraft, the safety regulations pertaining to said aircraft and system resources, and the position and capacity of said system resources.

10. A method as recited in claim 8, wherein:
said specified data is chosen from the group consisting of the temporally varying positions and trajectories of the aircraft and other vehicular assets and the mobile labor assets of said airline, the temporally varying weather conditions surrounding said aircraft and system resources, the flight handling characteristics of said aircraft, the safety regulations pertaining to said aircraft and system resources, and the position and capacity of said system resources.

11. A computer program product in a computer readable memory for allowing an airline to manage its operational assets for the transport of the passengers, luggage and cargo of said airline in such a manner as to allow the business and operational goals of said airline to be met to the highest degree possible, wherein said product utilizes specified data pertaining to said airline assets, passengers, luggage, cargo and goals, said product comprising:
a means for collecting and storing data on the status of said airline assets, passengers, luggage and cargo,
a means for processing said specified data and said status data to predict the outcomes that will be achieved for the transport of said passengers, luggage and cargo,
a means for processing said predicted outcomes to determine the degree to which said airline goals are expected to be met as a result of said predicted outcomes,
a means for identifying for a future point in time how the most recent specified and status data would have to feasibly change so that if such changed data were to be applicable at said future point in time that its use to predict said outcomes would yield results for the transport of said passengers, luggage and cargo that give a higher degree of attainment of said airline goals than that achieved by using said initially predicted outcomes,
a means for processing said feasible changes to identify the tasks that must be accomplished by said airline assets within the time period prior to said future point in time so as to make said identified changed data applicable at said future point in time,
a means for developing instructions for said airline assets as to how they are to perform said tasks, and
a means for communicating said instructions to said airline assets.

12. A computer program product as recited in claim 11, further comprising:
a means for, when a portion of said tasks require coordination chosen from the group consisting of coordination for regulatory control or non-regulatory coordination with others outside of said airline, obtaining said coordination approval for said airline assets to perform said tasks.

13. A computer program product as recited in claim 12, further comprising:
a means for monitoring the progress of said assets towards accomplishing said tasks so as to identify when a situation arises that will prevent one or more of said tasks from being accomplished in a timely manner so as to prevent the achievement of the outcomes necessary for said higher degree of attainment of said airline goals than that achieved by said initially predicted outcomes, and
a means for, when said situation is identified, beginning again the steps of identifying new feasible changes, processing said new feasible changes to identify new tasks that must be accomplished by said airline assets, developing new instructions for performing said new tasks, and communicating said new instructions.

14. A computer program product as recited in claim 13:
wherein said airline asset management takes place within the constraints of an aviation system having defined resources and sharing said system resources with the assets of another airline, and wherein said product further based upon specified data pertaining to said aviation system resources and said assets of other airline,
said product further comprising:
a means, included in said status data collecting and storing means, for the collection and storage of data on the status of said aviation system resources and the assets of said other airline, and
a means, included in said data processing means, for the processing of said specified data and said status data for said aviation system resources and said assets of said other airline.

15. A computer program product as recited in claim 14:
further comprising a means for assessing the accuracy of said collected status data and, for the purposes of processing said data, applying a weighting factor to said data that reflects said accuracy assessment, and
wherein said specified data is chosen from the group consisting of the temporally varying positions and trajectories of the aircraft and other vehicular assets and the mobile labor assets of said airline, the temporally varying weather conditions surrounding said aircraft and system resources, the flight handling characteristics of said aircraft, the safety regulations pertaining to said aircraft and system resources, and the position and capacity of said system resources.

16. A system, including a processor, memory, display and input device, that allows an airline to manage its operational assets for the transport of the passengers, luggage and cargo of said airline in such a manner as to allow the business and operational goals of said airline to be met to the highest degree possible, wherein said system utilizes specified data pertaining to said airline assets, passengers, luggage, cargo and goals, said system comprising:
a means for collecting and storing data on the status of said airline assets, passengers, luggage and cargo,
a means for processing said specified data and said status data to predict the outcomes that will be achieved for the transport of said passengers, luggage and cargo,
a means for processing said predicted outcomes to determine the degree to which said airline goals are expected to be met as a result of said predicted outcomes,
a means for identifying for a future point in time how the most recent specified and status data would have to feasibly change so that if such changed data were to be applicable at said future point in time that its use to predict said outcomes would yield results for the transport of said passengers, luggage and cargo that give a higher degree of attainment of said airline goals than that achieved by using said initially predicted outcomes,
a means for processing said feasible changes to identify the tasks that must be accomplished by said airline assets within the time period prior to said future point in time so as to make said identified changed data applicable at said future point in time,
a means for developing instructions for said airline assets as to how they are to perform said tasks, and
a means for communicating said instructions to said airline assets.

17. A system as recited in claim 16, further comprising:
a means for, when a portion of said tasks require coordination chosen from the group consisting of coordination for regulatory control or non-regulatory coordination with others outside of said airline, obtaining said coordination approval for said airline assets to perform said tasks.

18. A system as recited in claim 17, further comprising:
a means for monitoring the progress of said assets towards accomplishing said tasks so as to identify when a situation arises that will prevent one or more of said tasks from being accomplished in a timely manner so as to prevent the achievement of the outcomes necessary for said higher degree of attainment of said airline goals than that achieved by said initially predicted outcomes, and
a means for, when said situation is identified, beginning again the steps of identifying new feasible changes, processing said new feasible changes to identify new tasks that must be accomplished by said airline assets, developing new instructions for performing said new tasks, and communicating said new instructions.

19. A system as recited in claim 18:
wherein said airline asset management takes place within the constraints of an aviation system having defined resources and sharing said system resources with the assets of another airline, and wherein said system further based upon specified data pertaining to said aviation system resources and said assets of other airline,
said system farther comprising:
a means, included in said status data collecting and storing means, for the collection and storage of data on the status of said aviation system resources and the assets of said other airline, and
a means, included in said data processing means, for the processing of said specified data and said status data for said aviation system resources and said assets of said other airline.

20. A system as recited in claim 19:
further comprising a means for assessing the accuracy of said collected status data and, for the purposes of processing said data, applying a weighting factor to said data that reflects said accuracy assessment, and
wherein said specified data is chosen from the group consisting of the temporally varying positions and trajectories of the aircraft and other vehicular assets and the mobile labor assets of said airline, the temporally varying weather conditions surrounding said aircraft and system resources, the flight handling characteristics of said aircraft, the safety regulations pertaining to said aircraft and system resources, and the position and capacity of said system resources.
